(19) United States
(12) Patent Application Publication
(10) Pub. No.: US 2011/0243276 A1
(43) Pub. Date: Oct. 6, 2011

(54) WIRELESS DEMODULATION CIRCUIT

(75) Inventors: Jun OGAWA, Kyoto (JP); Takahiro Ichikura, Osaka (JP)

(73) Assignee: PANASONIC CORPORATION, Osaka (JP)

(21) Appl. No.: 13/159,180

(22) Filed: Jun. 13, 2011

Related U.S. Application Data
(63) Continuation of application No. PCT/JP2009/004674, filed on Sep. 17, 2009.

(30) Foreign Application Priority Data
Jan. 16, 2009 (JP) 2009-007826

(51) Int. Cl. H04L 27/22

(52) U.S. Cl. 375/329

(57) ABSTRACT

Positions of a group of points of code shift including a plurality of points of code shift and present in each code-shift site of a multi-valued FSK code are identified, a point of code shift correction amount including an amount of displacement between a center point of code shift centered among the group of points of code shift in a direction of time axis and each of the points of code shift is calculated based on the identified positions of the points of code shift, and the point of code shift is corrected on a time axis based on the calculated point of code shift correction amount.

### FIELD OF THE INVENTION

The present invention relates to a wireless demodulation circuit configured to perform a multi-valued FSK wireless communication using a FSK (frequency shift keying) signal which is one of frequency modulation signals, more particularly to a technology for more accurately correcting a data synchronization point in data judgment to enable fast data transmission.

### BACKGROUND OF THE INVENTION

The entire documents of Japanese patent application No. 2009-007826 filed on Jan. 16, 2009, which include the specification, drawings, and scope of claims, are incorporated herein by reference.

Conventionally, FSK wireless communication using a FSK (frequency shift keying) signal, which is one of FM (frequency modulation) signals, is often employed to wirelessly transmit various data. When data is transmitted by means of the FSK wireless communication, a carrier wave frequency is shifted depending on “1” or “0” of a digital signal to modulate the frequency, and a frequency-modulated high frequency signal is transmitted in the form of radio wave. When the transmitted high frequency signal is received by a FSK receiver to demodulate the transmitted data, the frequency component of a demodulated baseband signal obtained from a frequency voltage is compared to a given threshold value to determine a digital value, and transmission-origin data is obtained based on the determined digital value. It is preferable to use multiple values to enable fast data transmission in the narrow-band FSK wireless communication in view of effective use of frequencies. In the case of using multiple values (for example, four values), the carrier wave frequency is shifted depending on “00”, “01”, “11”, and “10” of a digital signal. As far as the same frequency band is used, the 4-valued FSK wireless communication requires more strictness in data judgment through comparison to the threshold value, making it necessary to more accurately determine a sampling point. To be able to transmit data at a high communication speed, therefore, a higher level of accuracy is demanded in acquiring synchronization between transmission and reception sides.

Conventionally, a multi-valued point of synchronization decision device constantly monitors a degree of modulation relative to a center frequency to decide a shift between code values away from the center frequency by an equal degree of modulation to determine a point of synchronization. In the event of the 4-valued FSK, as illustrated in FIG. 12, four different code shifts alone, which are code shift from “00” to “10” illustrated with Line L1, code shift from “01” to “11” illustrated with Line L2, code shift from “11” to “01” illustrated with Line L3, and code shift from “10” to “00” illustrated with Line L4, are used as a source of information for deciding a point of code shift. Then, a length of time as long as ½ of a sampling cycle T0 (T0/2) based on a calculated point of synchronization P₀ is added so that a data sampling point SP is determined.

In the code shift from “00” to “11”, a point of intersection with a first threshold value Th₁ is a point of code shift P₊₁, which is not included in point of synchronization candidates. In the code shift from “01” to “10” illustrated with a broken line, a point of intersection with the first threshold value Th₁ is a point of code shift P₋₁, which is not included in the point of synchronization candidates. These points of code shift are thus excluded from the point of synchronization candidates because these code shifts show different degrees of modulation from the center frequency on plus and minus sides.

### PRIOR ART DOCUMENT

### Patent Document

Patent Document 1: Unexamined Japanese Patent Applications Laid-Open No. 2007-251930

### SUMMARY OF THE INVENTION

### Problem to be Solved by the Invention

The conventional technique for determining the data sampling point can measure up to an expected performance in, for example, approximately a several 10-kbp communication. However, there is a problem in further improving a transmission rate in the future because there may be too little information of the point of synchronization depending on data configurations actually transmitted and received.

To detect the point of code shift which is a prerequisite for determining the point of synchronization in the 4-valued FSK, for example, only a point of code shift P₀ at the center of three points of intersection with the center threshold value Th₁, P₋₁, P₀, and P₊₁ is extracted as a point of synchronization as illustrated in FIGS. 12 and 13, whereas the other points of intersection P₋₁ and P₊₁ are rather avoided. The point of code shift P₀ is thus extracted because the point of code shift P₀ at the center the points of intersection is recognized as an ideal point of synchronization when the data sampling point is decided, and the center point of intersection P₀ recognized as the ideal point of synchronization is a point of greatest importance to calculate the data sampling point with a high accuracy. This is based on the technical concept that there should be only one ideal point of synchronization, therefore, there should be only one point of intersection based on which the ideal point of synchronization is extracted.

At the point of code shift P₋₁, the code shifts from “01” to “10”. At the point of code shift P₊₁, the code shifts from “00” to “11”. These points of code shift P₋₁ and P₊₁ are both away from the point of synchronization P₀ and inconsistent with each other. To detect the point of synchronization, therefore, it is preferable to use the point of code shift from “00” to “10” illustrated with Line L1 or a point of code shift from “01” to “11” illustrated with Line L2 as the point of synchronization, or a point of code shift from “10” to “00” illustrated with Line L3 or a point of code shift from “11” to “01” illustrated with Line L4 is preferably used as the point of synchronization. By using only the points of code shift away from the center frequency by an equal degree of modulation as the point of synchronization, the point of synchronization can be more accurately detected as illustrated in the point P₀.

Further, the point of code shift at which the 4-valued code shifts from “00” to “10” illustrated with Line L1 or the point of code shift at which the 4-valued code shifts from “10” to “00” illustrated with Line L3 may be selected as the point of synchronization. In other words, a point of code shift from a code value to another code value different by a largest degree of modulation may be selected as the point of synchronization.

However, the conventional technique described so far fails to obtain enough information of the point of synchronization depending on some data configurations actually transmitted and received. During fast data communication, therefore, a slight difference between transmission rates of the transmitter and the receiver results in a failure to follow the data sampling point for correction, deteriorating a communication performance. This is a bottleneck in achieving fast data transmission.

The present invention was accomplished in order to solve the technical problems. A main object of the present invention is to provide a wireless demodulation circuit which enables fast data transmission by more accurately deciding a data sampling point.

### Means for Solving the Problem

1) A wireless demodulation circuit according to the present invention comprises:

a digital demodulation unit configured to generate a demodulated baseband signal having a signal level variable in a direction of time axis by demodulating a multi-valued FSK signal on which a multi-valued FSK code is superimposed;

a data decision unit configured to generate a multi-valued demodulated data by comparing the signal level to a plurality of threshold values respectively having different levels;

a point of code shift detection unit configured to sequentially detecting a point of intersection at which the signal level of the demodulated baseband signal intersects with at least one of the plurality of threshold values as a point of code shift;

a point of synchronization determination unit configured to store each of a plurality of the points of code shift as a point of synchronization candidate and determine one of the stored point of synchronization candidates having a highest degree of certainty as a definite point of synchronization; and

a demodulated signal synchronous output unit configured to generate a synchronous digital clock and set a data sampling point based on the definite point of synchronization, extract a synchronous digital data from the multi-valued demodulated data at the set data sampling point, and output the extracted synchronous digital data and the synchronous digital clock, wherein

positions of a group of the points of code shift including the plurality of the points of code shift and present in each code-shift site of the multi-valued FSK code are identified, a point of code shift correction amount including an amount of displacement between a center point of code shift centered among the group of the points of code shift in the direction of time axis and each of the points of code shift is calculated based on the identified positions of the points of code shift, and the point of code shift is corrected on a time axis based on the calculated point of code shift correction amount.

The wireless demodulation circuit according to the present invention preferably further comprises:

a point of code shift correction amount calculation unit configured to identify the positions of the group of the points of code shift and calculate the point of code shift correction amount including the amount of displacement between the center point of code shift and each of the points of code shift based on the identified positions of the points of code shift; and

a point of code shift correction/point of synchronization candidate extraction unit configured to correct the point of code shift on the time axis based on the point of code shift correction amount.

In contrast to the conventional technique which handles only one center point of code shift, the present invention is technically characterized in that:
more points of code shift in the direction of time axis are all targeted and detected; and
the amount of displacement of each detected point of code shift from the center point of code shift is parameterized as the point of code shift correction amount (see differentials (P₀−P₋₁), (P₀−P₊₁) recited in exemplary embodiments described later), and the point of code shift is corrected based on the point of code shift correction amount and used as the point of synchronization candidate.

These technical characteristics were provided to deal with the conventional problem that there is not enough information to figure out the point of synchronization candidates during fast data transmission. To solve the technical problem, the present invention:
increases the information based on which the point of synchronization candidates are determined; and
in view of the disadvantage that the information thus increased becomes less accurate on the time axis, corrects the information, which is the point of code shift (point of displacement) on the time axis, based on the point of code shift correction amount to compensate for the disadvantage.

These arrangements are provided based on on the technical idea of the present invention far-advanced as compared to the conventional technology.

According to the present invention thus technically characterized, the data sampling point can be more accurately determined, so that the data can be more accurately decided during fast data transmission. When the point of synchronization is followed during wireless data reception, a clock error can be more accurately corrected in real time during communication, which greatly contributes to increase of a wireless communication speed. The point of code shift correction amount calculation unit is configured as recited in 2) and 4).

The following arrangement is necessary to be able to handle a plurality of points of code shift. The point of code shift is a point of intersection at which the demodulated baseband signal intersects with a center threshold value, however, it is not possible to identify which of a plurality of points of code shift on the time axis is the target point of intersection (intersection is made at a point in all of the points of code shift). Unless the point of intersection is identified, it is pointless to handle the plurality of points of code shift. To identify which of the points of code shift on the time axis is the detected point of intersection, it is necessary to have information in the direction of time axis. The information in the direction of time axis includes information indicating the multi-valued FSK code shift, and information indicating a differential between a center threshold value centered among the plurality of threshold values in a level width direction and a voltage level after voltage change. Because the differential information alone is not enough to identify the point of code shift, an amount of the voltage change in the demodulated baseband signal outputted from the digital demodulation unit is used as well.

2) In the wireless demodulation circuit according to a preferred mode of the present invention, the point of code shift detection unit sequentially detects a point of intersection at which the signal level of the demodulated baseband signal intersects with a center threshold value centered among the plurality of threshold values in a level width direction as the point of code shift, and

the point of code shift correction amount calculation unit decides a code shift of the multi-valued FSK code relative to the center threshold value in the group of the points of code shift, identifies positions of the group of the points of code shift based on the decided code shift, and calculates the point of code shift correction amount based on the identified positions of the points of code shift.

The point of code shift correction amount calculation unit recited in 2) decides the code shift of the multi-valued FSK code from the demodulated data generated by the data decision unit and information on the point of code shift detected by the point of code shift detection unit, and figures out which of the points of code shift is the detected point of code shift from the decided code shift (see P₋₁, P₀, P₊₁ recited in exemplary embodiments described later). The code shift includes such information in the direction of time axis as “00”→“11”, “00”→“10”, “01”→“11”, “01”→“10”, . . . , based on which the position of the detected point of code shift in the direction of time axis can be identified. The point of code shift correction amount calculation unit thus configured generates a point of code shift correction amount information based on the identified position (see differentials (P₀−P₁), (P₀−P₊₁) recited in exemplary embodiments described later) based on the identified position, and supplies the generated point of code shift correction amount information to the point of code shift correction/point of synchronization candidate extraction unit. Based on the point of code shift correction amount information supplied from the point of code shift correction amount calculation unit, the point of code shift correction/point of synchronization candidate extraction unit corrects the point of code shift indicated by the point of code shift information supplied from the point of code shift detection unit on the time axis and uses the corrected point of code shift as the point of synchronization candidate, and supplies the point of synchronization candidate to the point of synchronization determination unit. The point of synchronization candidate thus obtained has a high positional accuracy in the direction of time axis because it is the point of code shift corrected on the time axis based on the point of code shift correction amount calculated from the code shift of the multi-valued FSK code. The point of synchronization determination unit finds out the definite point of synchronization from the point of synchronization candidates positionally very accurate in the direction of time axis. The demodulated signal synchronous output unit figures out the data sampling point from the definite point of synchronization, and generates the synchronous digital data and the synchronous digital clock from the demodulated data. The synchronous digital data and the synchronous digital clock thus obtained are positionally very accurate in the direction of time axis.

According to the preferred mode, more points of code shift are used to calculate the point of code shift correction amount from the code shift of the multi-valued FSK code in contrast to the prior art wherein only one point of code shift is handled, and the point of code shift is corrected on the time axis based on the calculated point of code shift correction amount and used as the point of synchronization candidate. Therefore, the data sampling point can be more accurately obtained so that data judgment can be more accurate during fast data transmission. When the point of synchronization is followed during wireless data reception, a clock error can be more accurately corrected in real time during communication, which greatly contributes to increase of a wireless communication speed.

3) In the wireless demodulation circuit according to another preferred mode of the present invention, the point of code shift detection unit sequentially detects a point of intersection at which the signal level of the demodulated baseband signal intersects with each of the plurality of threshold values as the point of code shift, and

the point of code shift correction amount calculation unit decides a code shift of the multi-valued FSK code relative to each of the plurality of threshold values in the group of the points of code shift, identifies positions of the group of the points of code shift based on the decided code shift, and calculates the point of code shift correction amount based on the identified positions of the points of code shift.

According to the another preferred mode, wherein the points at which the demodulated baseband signal intersects with all of the threshold values are all handled as the point of code shift, more information is available for correcting the point of code shift, and the data sampling point can be more accurately obtained in real time.

4) In the wireless demodulation circuit according to still another preferred mode of the present invention, the point of code shift detection unit sequentially detects a point of intersection at which the signal level of the demodulated baseband signal intersects with a center threshold value centered among the plurality of threshold values in a level width direction as the point of code shift, and

the point of code shift correction amount calculation unit calculates an amount of voltage change of the demodulated baseband signal and a voltage level of the demodulated baseband signal after the voltage change in each code-shift site of the multi-valued FSK code, identifies positions of the group of the points of code shift based on the amount of voltage change and a differential between the center threshold value centered among the plurality of threshold values in the level width direction and the voltage level after the voltage change, and calculates the point of code shift correction amount based on the identified positions of the points of code shift.

The point of code shift correction amount calculation unit recited in 4) calculates the amount of voltage change of the demodulated baseband signal and the voltage level of the demodulated baseband signal after the voltage change in each code-shift site of the multi-valued FSK code, and identifies positions of the group of the points of code shift based on the amount of voltage change and the differential between the center threshold value centered among the plurality of threshold values in the level width direction and the voltage level after the voltage change. The voltage change starts with a certain level of code-compliant voltage, increasing or decreasing the voltage. When the voltage level reaches a different level and stays at the level for a certain period of time, the level then becomes a different code-compliant voltage level. The amount of voltage change is a difference between a level of code-compliant voltage and another level of code-compliant voltage level. Though the amount of voltage change per se does not involve any information related to the time axis, a positional relationship of the point of code shift to the center point of code shift (whether the detected point of code shift is temporally before or after the point of intersection at which the demodulated baseband signal intersects with the center threshold value on the time axis) can be judged based on the differential between the voltage level after the voltage change and the center threshold value. Thus, the detected point of code shift can be identified on the time axis (the points of code shift can be distinguished from one another). After the detected point of code shift is thus identified, the point of code shift correction amount calculation unit generates the point of code shift correction amount (see differentials (P₀−P₋₁), (P₀−P₊₁) recited in exemplary embodiments described later) and supplies the generated correction amount to the point of code shift correction/point of synchronization candidate extraction unit. Based on the supplied point of code shift correction amount, the point of code shift correction/point of synchronization candidate extraction unit corrects the point of code shift on the time axis and uses the corrected point of code shift as the point of synchronization candidate. The point of synchronization candidate, which was obtained by correcting the point of code shift on the time axis based on the point of code shift correction amount, has a high positional accuracy on the time axis. The point of synchronization determination unit obtains the definite point of synchronization from the point of synchronization candidates thus positionally accurate, and the demodulated signal synchronous output unit figures out the data sampling point based on the definite point of synchronization. Then, the synchronous digital data and the synchronous digital clock are generated from the demodulated data based on the obtained information. The synchronous digital data and the synchronous digital clock thus obtained are positionally highly accurate in the direction of time axis. This mode of the present invention enables the code shift to be accurately known independent of the data sampling point.

According to the still another preferred mode, more points of code shift are used to calculate the point of code shift correction amount from the amount of voltage change of the demodulated baseband signal and the relationship to the center point of code shift in contrast to the prior art wherein only one point of code shift is handled, and the point of code shift is corrected on the time axis based on the calculated point of code shift correction amount and used as the point of synchronization candidate. Therefore, the data sampling point can be more accurately obtained so that data judgment can be more accurate during fast data transmission. When the point of synchronization is followed during fast data reception, a clock error can be more accurately corrected in real time during communication, which greatly contributes to increase of a wireless communication speed. A particular advantage is to be able to accurately calculate the point of code shift correction amount. Therefore, the data sampling point can be more accurately obtained in a start-up operation where the data sampling point is unlikely to be accurate. As a result, the data sampling point in the start-up operation can be more quickly and accurately narrowed down.

5) The wireless demodulation circuit according to still another preferred mode of the present invention further comprises:

a second point of code shift correction amount calculation unit; and

a third point of code shift correction amount calculation unit, wherein

the point of code shift detection unit sequentially detects a second point of intersection at which the signal level of the demodulated baseband signal intersects with a second center threshold value having a higher level than the center threshold value as a second point of code shift,

the point of code shift detection unit sequentially detects a third point of intersection at which the signal level of the demodulated baseband signal intersects with a third center threshold value having a lower level than the center threshold value as a third point of code shift,

the second point of code shift correction amount calculation unit identifies positions of a group of the second points of code shift including a plurality of the second points of code shift and present in each code-shift site of the multi-valued FSK code, and calculates a second point of code shift correction amount including an amount of displacement between a second center point of code shift centered among the group of the second points of code shift in the direction of time axis and each of the second points of code shift based on the identified positions of the second points of code shift,

the third point of code shift correction amount calculation unit identifies positions of a group of the third points of code shift including a plurality of the third points of code shift and present in each code-shift site of the multi-valued FSK code, and calculates a third point of code shift correction amount including an amount of displacement between a third center point of code shift centered among the group of

the third points of code shift in the direction of time axis and each of the third points of code shift based on the identified positions of the third points of code shift, and the point of code shift correction/point of synchronization candidate extraction unit corrects the point of code shift on the time axis based on the point of code shift correction amount, corrects the second point of code shift on the time axis based on the second point of code shift correction amount, and corrects the third point of code shift on the time axis based on the third point of code shift correction amount.

The wireless demodulation circuit according to the still another preferred mode uses the multiple threshold values to detect the point of code shift in a manner similar to 3), thereby more accurately calculating the point of code shift correction amount. As a result, the data sampling point can be more accurately determined in real time. Further, the wireless demodulation circuit thus configured can be simplified.

### Effect of the Invention

According to the present invention, it is decided which of the plurality of points of code shift in the direction of time axis is the detected point of code shift based on the plurality of points of code shift in the direction of time axis in place of using the center point of code shift alone as conventionally done, and the amount of displacement of the point of code shift from the center point of code shift is used as the point of code shift correction amount, so that the detected point of code shift is corrected on the time axis based on the point of code shift correction amount and used as the point of synchronization candidate. Therefore, the data sampling point can be more accurately determined so that data judgment can be more accurate during fast data transmission. When the point of synchronization is followed during wireless data reception, a clock error can be more accurately corrected in real time during communication, which greatly contributes to increase of a wireless communication speed.

The technical advantages described so far enable more accurate data judgment and synchronization between transmission and reception sides in the multi-valued FSK wireless communication, thereby improving wireless reception characteristics.

### BRIEF DESCRIPTION OF THE DRAWINGS

FIG. 1 is a block diagram of a wireless demodulation circuit according to an exemplary embodiment 1 of the present invention.

FIG. 2 is a timing chart illustrating an operation of the wireless demodulation circuit according to the exemplary embodiment 1.

FIG. 3 illustrates code shifts during 4-valued FSK wireless communication in the wireless demodulation circuit according to the exemplary embodiment 1.

FIG. 4 is a block diagram of a wireless demodulation circuit according to an exemplary embodiment 2 of the present invention.

FIG. 5 is a timing chart illustrating an operation of the wireless demodulation circuit according to the exemplary embodiment 2.

FIG. 6 is a timing chart illustrating the operation of the wireless demodulation circuit according to the exemplary embodiment 2.

FIG. 7 illustrates code shifts during 4-valued FSK wireless communication in the wireless demodulation circuit according to the exemplary embodiment 2.

FIG. 8 is a block diagram of a wireless demodulation circuit according to an exemplary embodiment 3 of the present invention.

FIG. 9 illustrates code shifts during 4-valued FSK wireless communication in the wireless demodulation circuit according to the exemplary embodiment 3.

FIG. 10 is a block diagram of a wireless demodulation circuit according to an exemplary embodiment 4 of the present invention.

FIG. 11 illustrates code shifts during 4-valued FSK wireless communication in the wireless demodulation circuit according to the exemplary embodiment 4.

FIG. 12 illustrates code shifts during 4-valued FSK wireless communication in a conventional wireless demodulation circuit.

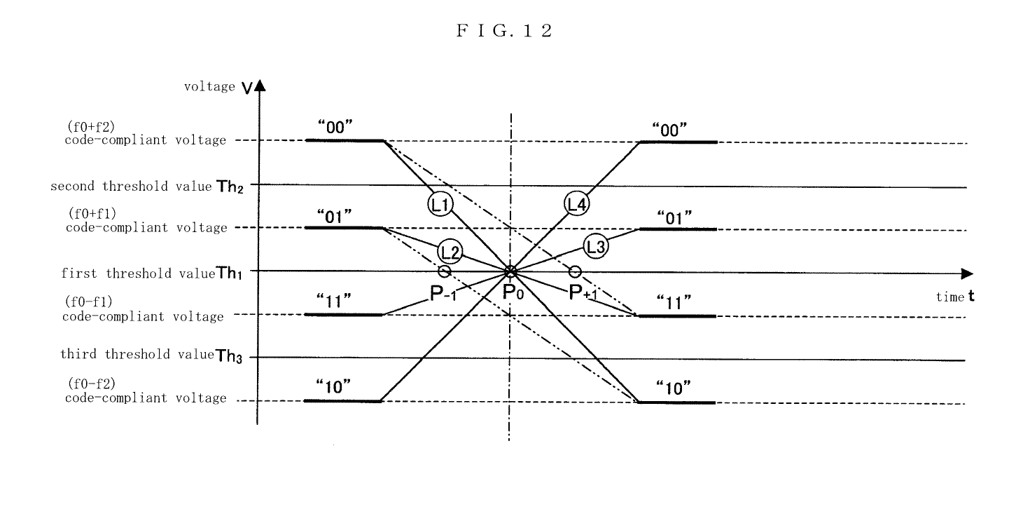

FIG. 13 is a timing chart illustrating an operation of the conventional wireless demodulation circuit.

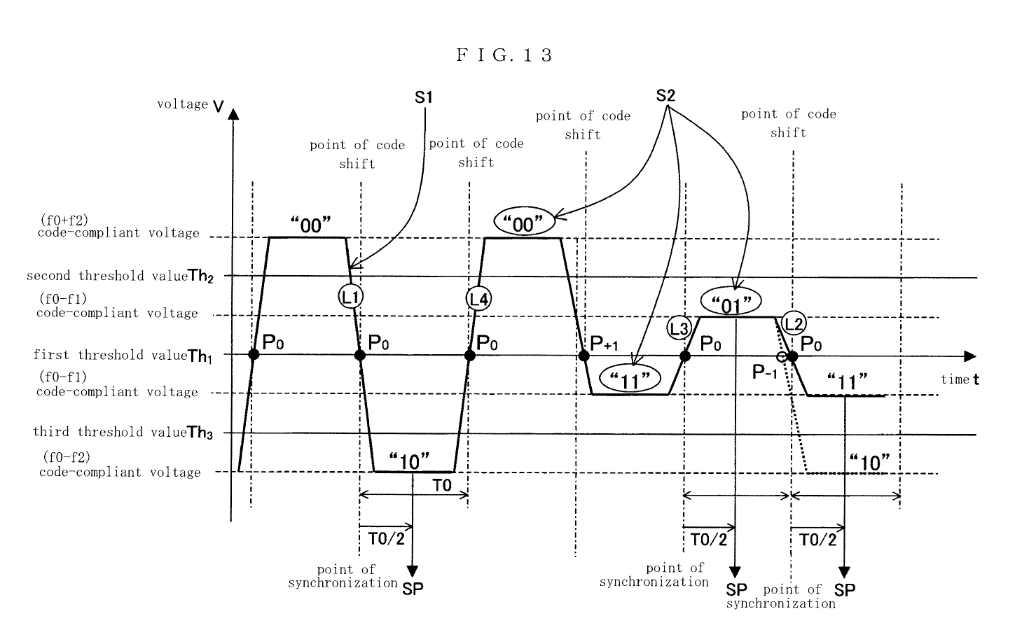

### EXEMPLARY EMBODIMENTS FOR CARRYING OUT THE INVENTION

### Exemplary Embodiment 1

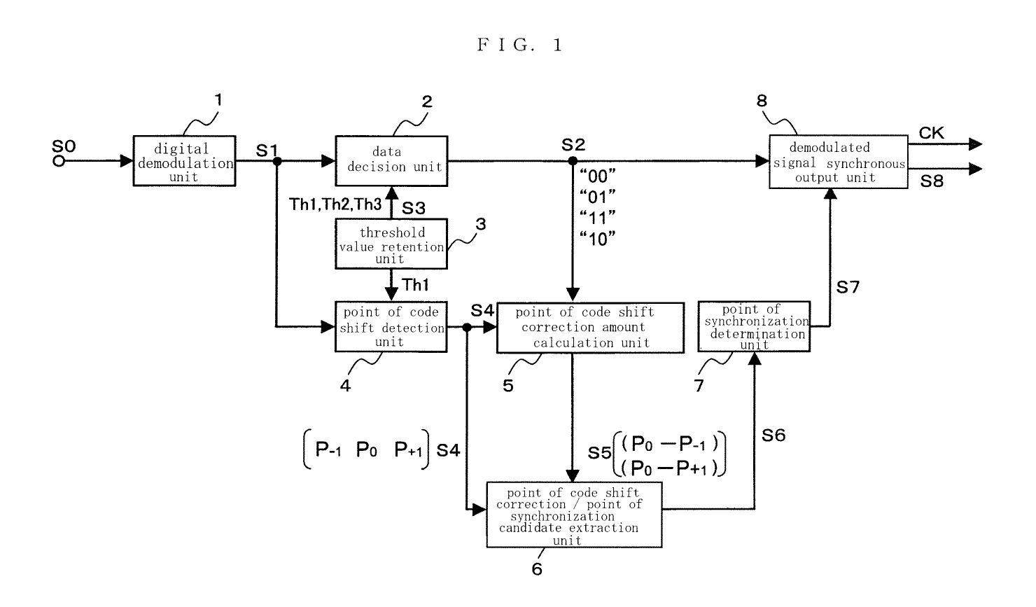

FIG. 1 is a block diagram of a wireless demodulation circuit according to an exemplary embodiment 1 of the present invention, illustrating a circuit configuration for determining a point of synchronization in multi-valued FSK wireless communication.

The wireless demodulation circuit according to the present exemplary embodiment has a digital demodulation unit 1, a data decision unit 2, a threshold value retention unit 3, a point of code shift detection unit 4, a point of code shift correction amount calculation unit 5, a point of code shift correction/point of synchronization candidate extraction unit 6, a point of synchronization determination unit 7, and a demodulated signal synchronous output unit 8.

The digital demodulation unit 1 performs a frequency voltage conversion to a multi-valued FSK signal S0 which is a high frequency signal down-converted, filtered, and then digitalized, and outputs a demodulated baseband signal S1 thereby obtained.

The data decision unit 2 compares the demodulated baseband signal S1 inputted from the digital demodulation unit 1 to a plurality of threshold values having different levels Th₁, Th₂, and Th₃, and outputs a multi-valued data S2 (“00”, “01”, “11”, and “10”) obtained from the comparison.

The threshold value retention unit 3 retains therein the plurality of threshold values (first—third threshold values Th₁, Th₂, and Th₃) used in the comparison by the data decision unit 2, and supplies the retained threshold values to the data decision unit 2 as a threshold value information S3.

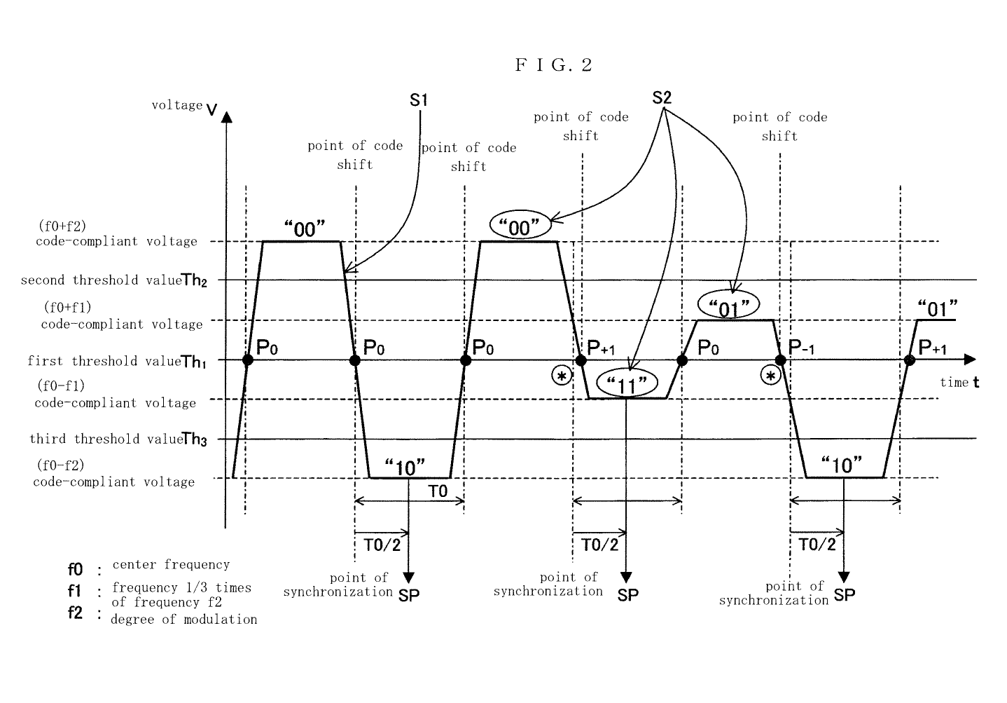

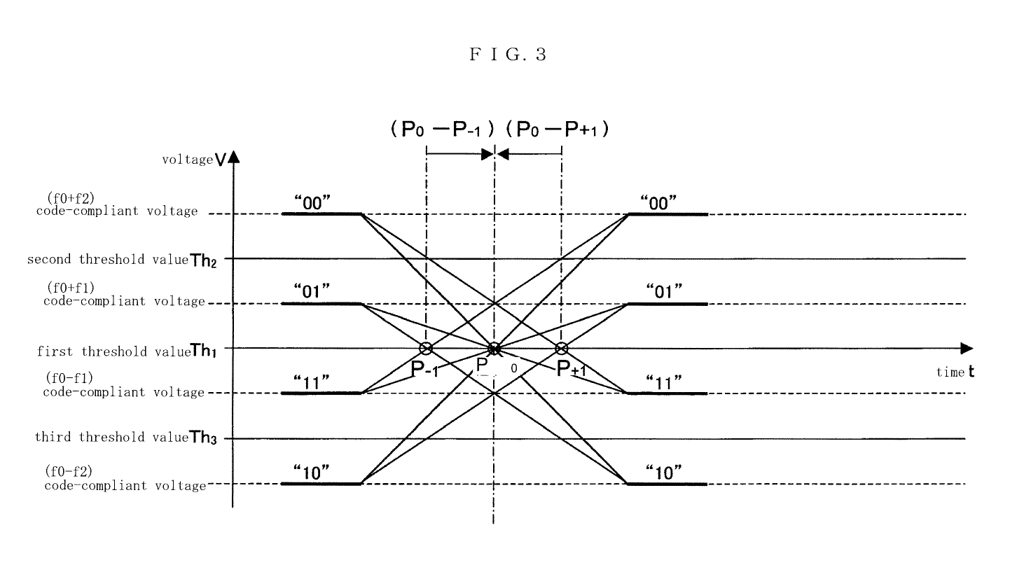

The point of code shift detection unit 4 detects a point of code shift of the demodulated baseband signal S1 supplied from the digital demodulation unit 1, which is a point of intersection at which a the demodulated baseband signal S1 intersects with as a center threshold value which is the first threshold value Th₁ (see FIGS. 2 and 3) as a point of code shift. Then, the point of code shift detection unit 4 outputs a point of code shift information S4 indicating which of points of code shift P₋₁, P₀, and P₊₁ is the detected point of code shift.

The point of code shift correction amount calculation unit 5 decides which of the code shifts is generated in a multi-valued FSK code superimposed on the multi-valued FSK signal based on the demodulated data S2 supplied from the data decision unit 2 (“00”, “01”, “11”, and “10”) and the point of code shift information S4 (P₋₁, P₀, and P₊₁) supplied from the point of code shift detection unit 4, identifies positions of a group of the points of code shift including a plurality of points of code shift and present in each code-shift site of the multi-valued FSK code based on an obtained decision result, generates a point of code shift correction amount information S5 [(P₀−P₋₁), (P₀−P₊₁), or 0] based on the identified positions of the points of code shift, and then outputs the generated point of code shift correction amount information S5.

The point of code shift correction/point of synchronization candidate extraction unit 6 corrects the point of code shift information S4 supplied from the point of code shift detection unit 4 based on the point of code shift correction amount information S5 [(P₀−P₋₁), (P₀−P₊₁), or 0] supplied from the point of code shift correction amount calculation unit 5, and outputs a correction result thereby obtained as a point of synchronization candidate information S6.

The point of synchronization determination unit 7 stores therein the point of synchronization candidate information S6 which is the correction result obtained by the point of code shift correction/point of synchronization candidate extraction unit 6, retains the point of synchronization candidate most often stored therein as a most definite point of synchronization, and outputs the definite point of synchronization retained therein as a definite point of synchronization information S7.

The demodulated signal synchronous output unit 8 calculates a data sampling point SP based on the definite point of synchronization information S7 supplied from the point of synchronization determination unit 7, and generates a synchronous digital clock CK synchronizing with the calculated data sampling point SP and a transmission rate of the demodulated data S2 supplied from the data decision unit 2. The demodulated signal synchronous output unit 8 further outputs the demodulated data synchronizing with the synchronous digital clock CK as a synchronous digital data S8.

An operation of the wireless demodulation circuit according to the present exemplary embodiment thus configured is described referring to a timing chart illustrated in FIG. 2 and code shifts during 4-valued FSK wireless communication illustrated in FIG. 3. In FIGS. 2 and 3, a plurality of code-compliant voltages are respectively associated with “00”, “01”, “11”, and “10”. f0 is a center frequency, f2 is a frequency indicating a degree of modulation, and f1 is a frequency ⅓ times of the frequency f2. The code-compliant voltages illustrated in the drawings are not detected in the exemplary embodiment 1 and an exemplary embodiment 2 but are detected in exemplary embodiments 3 and 4.

The multi-valued FSK signal (on which the multi-valued FSK code is superimposed), which is a high frequency signal, is down-converted to be digitally processable at slow processing speeds, and then filtered so that any signals outside a desirable frequency band are removed therefrom. The multi-valued FSK signal thus processed is inputted to the digital demodulation unit 1 as a digitalized multi-valued FSK signal S0. The digital demodulation unit 1 performs a frequency voltage conversion to the multi-valued FSK signal S0 and outputs a conversion result thereby obtained to the data decision unit 2 and the point of code shift detection unit 4 as the demodulated baseband signal S1. Any of conventionally available techniques can be employed in the frequency voltage conversion.

The demodulated baseband signal S1 outputted from the digital demodulation unit 1 and the threshold value information S3 outputted from the threshold value retention unit 3 (first—third threshold values Th₁, Th₂, and Th₃) are inputted to the data decision unit 2. The data decision unit 2 compares the demodulated baseband signal S1 to the threshold value information S3 (first—third threshold values Th₁, Th₂, and Th₃). A comparison result thus obtained shows any of “00”, “01”, “11”, and “10”. The data decision unit 2 outputs the comparison result to the point of code shift correction amount calculation unit 5 and the demodulated signal synchronous output unit 8 as the demodulated data S2. Any storage device may be used as the threshold value retention unit 3 as far as the threshold value retention unit 3 (first—third threshold values Th₁, Th₂, and Th₃) can be retained therein. Examples of the threshold value retention unit 3 are fixed value, ROM, RAM, and register. In the description of the operation given below, a register is used. Of a number of different multi-valued FSK modulations, 4-valued FSK modulation is described below.

In the case where the degree of FSK modulation increases to 8-valued modulation or 16-valued modulation, number of threshold values should increase accordingly, making it necessary to retain a corresponding number of threshold values to be retained. In the description given below to the 4-valued FSK modulation, the present invention is applied to a system wherein a modulation frequency is modulated from a higher level, in the order of “00”, “01”, “11”, and “10” as illustrated in FIGS. 2 and 3.

In the system, three threshold values are used to decide code values. The first threshold value Th₁, which is a center threshold value, is used to decide code values “01” and “11”. The second threshold value Th₂ is used to decide code values “00” and “01”. The third threshold value Th₃ is used to decide code values “11” and “10”.

The data decision unit 2 compares the code values to the first—third threshold values Th₁, Th₂, and Th₃ to decide the code values, and outputs a data decision result thereby obtained to the demodulated signal synchronous output unit 8 and the point of code shift correction amount calculating unit 5 as the demodulated data S2 (“00”, “01”, “11”, and “10”).

The demodulated baseband signal S1 outputted from the digital demodulation unit 1 is also supplied to the point of code shift detection unit 4, and the point of code shift (any of P₋₁, P₀, and P₊₁) is detected there. There are various technical options for detecting the point of code shift in the demodulated baseband signal S1. The present exemplary embodiment detects a zero intersection point as the point of code shift, which is the simplest detection method. The demodulated baseband signal S1 is digital data. Expressing the demodulated baseband signal S1 using complement numbers of 2, a most significant bit is a coding bit. A point at which the coding bit shifts from “0” to “1” and a point at which the coding bit shifts from “1” to “0” are used as the point of code shift (zero intersection point).

The point of code shift detection unit 4 over-samples the demodulated baseband signal S1 to detect the point of code shift. As the demodulated baseband signals S1 are over-sampled more often, the point of code shift can be more accurately detected. Describing the mechanism referring to 10-fold oversampling, there are 0-9 points of code shift as timing points. The point of code shift detection unit 4 decides which of the 0-9 points of code shift is the detected point of code shift, and transmits a decision result to the point of code shift correction amount calculation unit 5 and the point of code shift correction/point of synchronization candidate extraction unit 6 as the point of code shift information S4 (P₋₁, P₀, P₊₁).

The demodulated data S2 (“00”, “01”, “11”, and “10”) outputted from the data decision unit 2 and the point of code shift information S4 (P₋₁, P₀, P₊₁) outputted from the point of code shift detection unit 4 are supplied to the point of code shift correction amount calculation unit 5. The point of code shift correction amount calculation unit 5 decides which of the code shifts is generated in the demodulated baseband signal S1 based on the demodulated data S2. In the code shifts illustrated in FIG. 2, there are 3×4=12 code shifts. The point of code shift correction amount calculation unit 5 decides the code shift of the demodulated baseband signal S1 to decide which of the points of code shift P₋₁, P₀, P₊₁ that the demodulated baseband signal S1 passed through. The following three decision criteria are used for the decision of the points of code shift P₋₁, P₀, P₊₁.

### Decision Criterion 1

The demodulation baseband S1 intersects with the center point of code shift P₀ in the following code shifts. There are a plurality of points of code shift (three points P₋₁, P₀, P₊₁ in the present invention), and a point of code shift centered among the three points P₋₁, P₀, P₊₁ in the direction of time axis is called the center point of code shift P₀. The center point of code shift P₀ is conventionally an ideal point of code shift Pᵢ.

code shift from the first level “00” to the fourth level “10”

code shift from the fourth level “10” to the first level “00”

code shift from the second level “01” to the third level “11”

code shift from the third level “11” to the second level “01”

### Decision Criterion 2

The demodulation baseband S1 intersects with the minus-shifted point of code shift P₋₁ in the following code shifts. Among the points of code shift P₋₁, P₀, P₊₁, the minus-shifted point of code shift P₋₁ is a point of code shift on the upstream side of the center point of code shift P₀ in the direction of time axis.

code shift from the second level “01” to the fourth level “10”

code shift from the third level “11” to the first level “00”

### Decision Criterion 3

The demodulation baseband S1 intersects with the plus-shifted point of code shift P₋₁ in the following code shifts. Among the points of code shift P₋₁, P₀, P₊₁, the plus-shifted point of code shift P₋₁ is a point of code shift on the downstream side of the center point of code shift P₀ in the direction of time axis.

code shift from the first level “00” to the third level “11”

code shift from the fourth level “10” to the second level “01”

The point of code shift correction amount calculation unit 5 identifies positions of a group of points of code shift including a plurality of points of code shift and present in each code-shift site of the multi-valued FSK code, and calculates the point of code shift correction amount information S5 including an amount of displacement between the center point of code shift centered among the group of points of code shift in the direction of time axis and each of the points of code shift. More specifically, the point of code shift correction amount calculation unit 5 transmits a differential (P₀−P₋₁) between the center point of code shift P₀ and the minus-shift point of code shift P₋₁ or a differential [(P₀−P₊₁): negative value] between the center point of code shift P₀ and the plus-shifted point of code shift P₊₁ to the point of code shift correction/point of synchronization candidate extraction unit 6 as the point of code shift correction amount information S5.

The point of code shift information S4 (P₋₁, P₀, P₊₁) outputted from the point of code shift detection unit 4 and the point of code shift correction amount information S5 [(P₀−P₋₁), (P₀−P₊₁) or 0] outputted from the point of code shift correction amount calculation unit 5 are inputted to the point of code shift correction/point of synchronization candidate extraction unit 6. The point of code shift correction/point of synchronization candidate extraction unit 6 corrects the point of code shift information S4 (point of code shift) based on the point of code shift correction amount information S5, and outputs the corrected point of code shift information S4 (including the corrected point of code shift) to the point of synchronization determination unit 7 as the point of synchronization candidate information S6 (including the point of synchronization candidate) A symbol * illustrated in FIG. 2 denotes the point of synchronization at which the correction is made.

The point of synchronization determination unit 7 stores therein the point of synchronization candidate information S6 supplied from the point of code shift correction/point of synchronization candidate extraction unit 6. The point of synchronization determination unit 7 then determines the point of synchronization candidate most likely to be the definite point of synchronization, and retains information which identifies the point of synchronization candidate determined as definite as the definite point of synchronization information S7. Because the values practically taken as the information are 0-9, counters are provided for the respective timing points so that a count value of any relevant one of the counters is increased by 1 every time when the information is transmitted. The point of synchronization determination unit 7 retains therein the information S7 indicating the point of code shift having a largest count value as the definite point of synchronization, and outputs the definite point of synchronization information S7 retained therein to the demodulated signal synchronous output unit 8.

The data decision unit 2 outputs the demodulated data S2 (“00”, “01”, “11”, and “10”), which is the data decision result, to the demodulated signal synchronous output unit 8. The demodulated signal synchronous output unit 8 generates the synchronous digital clock CK depending on the transmission rate known in advance. As illustrated in FIG. 2, the demodulated signal synchronous output unit 8 sets the data sampling point SP at a point having a time length ½ times of the sampling cycle T0 (T0/2) from the definite point of synchronization based on the definite point of synchronization information S7 inputted from the point of synchronization determination unit 7, decides the value of the demodulated data S2 at the set data sampling point SP, and outputs a decision result thereby obtained as the synchronous digital data S8. To generate the synchronous digital clock CK, the demodulated signal synchronous output unit 8, in the case of using a reception-side data sampling timing of the synchronous digital data S8 as a fall timing, generates the synchronous digital clock CK that rises at the point indicated by the definite point of synchronization information S7 and falls at the data sampling point SP. In the case of the demodulated data S2 having the value of “00”, the demodulated signal synchronous output unit 8 generates two bits “0” and “0” as the synchronous digital data S8 and outputs the generated bits in synchronization with the synchronous digital clock CK.

As described so far, the present exemplary embodiment obtains a larger number of point of synchronization candidates by correcting the detected point of code shift based on the code shift amount before data sampling, thereby improving the accuracy of data judgment. A favorable result thereby obtained is to prevent reception characteristics from deteriorating when the transmission rate is increased.

### Exemplary Embodiment 2

To detect the point of code shift, the exemplary embodiment 1 uses the first threshold value Th₁ alone to detect the point of code shift. An exemplary embodiment 2 of the present invention uses first—third threshold values Th₁, Th₂, and Th₃ to detect the point of code shift.

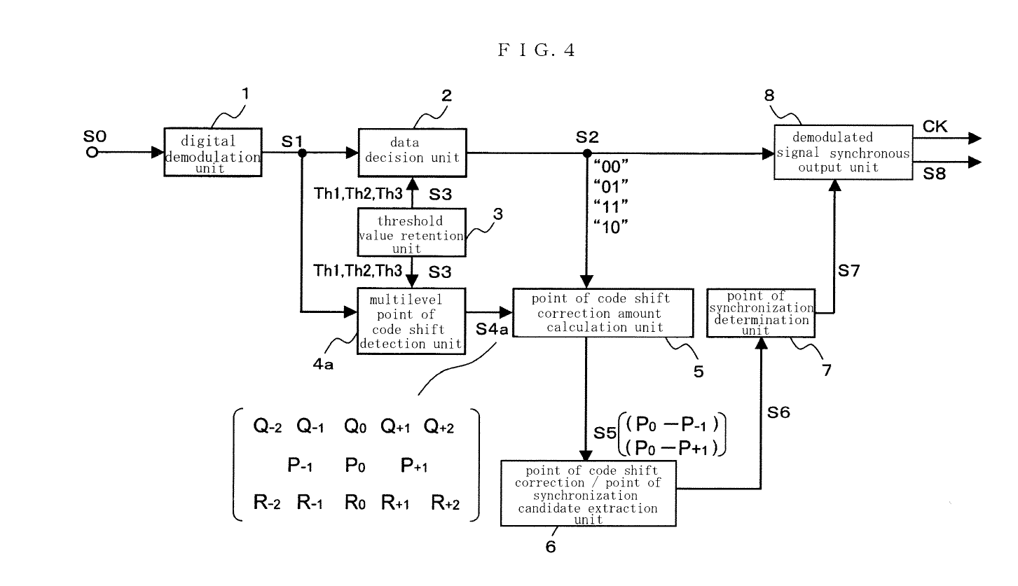

FIG. 4 is a block diagram of a wireless demodulation circuit according to the exemplary embodiment 2. The same reference symbols as those illustrated in FIG. 1 according to the exemplary embodiment 1 denote the same structural elements. The present exemplary embodiment is technically characterized as follows. In place of the point of code shift detection unit 4 according to the exemplary embodiment 1, a multilevel point of code shift detection unit 4a is provided. The demodulated baseband signal S1 outputted from the digital demodulation unit 1 and the threshold value information S3 (Th₁, Th₂, and Th₃) outputted from the threshold value retention unit 3 are inputted to the multilevel point of code shift detection unit 4a. The multilevel point of code shift detection unit 4a detects points at which the demodulated baseband signal S1 intersects with the first—third threshold values Th₁, Th₂, and Th₃ as the point of code shift, and outputs a multilevel point of code shift information S4a indicating the detected points of code shift S4a (P₋₁, P₀, P₊₁, Q₋₂, Q₋₁, Q₀, Q₊₁, Q₊₂, R₋₂, R₋₁, R₀, and R₊₁, R₊₂).

The first threshold value Th₁ is a center threshold value centered among the threshold values Th₁, Th₂, and Th₃ in a level width direction. The second threshold value Th₂ is a threshold value on the upper side of the first threshold value Th₁ in the level width direction among the threshold values Th₁, Th₂, and Th₃. The third threshold value Th₃ is a threshold value on the lower side of the first threshold value Th₁ in the level width direction among the threshold values Th₁, Th₂, and Th₃.

The points of code shift P₋₁, P₀, and P₊₁ are points at which the signal level of the demodulated baseband signal intersects with the first threshold value Th₁. The center point of code shift P₀ is a point of code shift centered among the points of code shift P₋₁, P₀, and P₊₁ in the direction of time axis. The center point of code shift P₀ is conventionally an ideal point of code shift Pᵢ. The point of code shift P₋₁ is a point of code shift on the upstream side of the center point of code shift P₀ in the direction of time axis among the points of code shift P₋₁, P₀, and P₊₁. The point of code shift P₊₁ is a point of code shift on the downstream side of the center point of code shift P₀ in the direction of time axis among the points of code shift P₋₁, P₀, and P₊₁.

The points of code shift Q₋₂, Q₋₁, Q₀, Q₊₁, Q₊₂ are points at which the signal level of the demodulated baseband signal intersects with the second threshold value Th₂. The center point of code shift Q₀ is a point of code shift centered among the points of code shift Q₋₂, Q₋₁, Q₀, Q₊₁, Q₊₂ in the direction of time axis. The center point of code shift Q₀ is conventionally an ideal point of code shift Qᵢ The point of code shift Q₋₁ is a point of code shift on the upstream side of the center point of code shift Q₀ in the direction of time axis among the points of code shift Q₋₂, Q₋₁, Q₀, Q₊₁, Q₊₂. The point of code shift Q₋₂ is a point of code shift on the upstream side of the point of code shift Q₋₁ in the direction of time axis among the points of code shift Q₋₂, Q₋₁, Q₀, Q₊₁, Q₊₂. The point of code shift Q₊₁ is a point of code shift on the downstream side of the center point of code shift Q₀ in the direction of time axis among the points of code shift Q₋₂, Q₋₁, Q₀, Q₊₂. The point of code shift Q₊₂ is a point of code shift on the downstream side of the point of code shift Q₊₁ in the direction of time axis among the points of code shift Q₋₂, Q₋₁, Q₀, Q₊₁, Q₊₂.

The points of code shift R₋₂, R₋₁, R₀, R₊₁, R₊₂ are points at which the signal level of the demodulated baseband signal intersects with the third threshold value Th₃. The center point of code shift R₀ is a point of code shift centered among the points of code shift R₋₂, R₋₁, R₀, R₊₁, R₊₂ in the direction of time axis. The center point of code shift R₀ is conventionally an ideal point of code shift Rᵢ The point of code shift R₋₁ is a point of code shift on the upstream side of the center point of code shift R₀ in the direction of time axis among the points of code shift R₋₂, R₋₁, R₀, R₊₁, R₊₂. The point of code shift R₋₂ is a point of code shift on the upstream side of the point of code shift R₋₁ in the direction of time axis among the points of code shift R₋₂, R₋₁, R₀, R₊₁, R₊₂. The point of code shift R₊₁ is a point of code shift on the downstream side of the center point of code shift R₀ in the direction of time axis among the points of code shift R₋₂, R₋₁, R₀, R₊₁, R₊₂. The point of code shift R₊₂ is a point of code shift on the downstream side of the point of code shift R₊₁ in the direction of time axis among the points of code shift R₋₂, R₋₁, R₀, R₊₂.

The demodulated data S2 outputted from the data decision unit 2 and the multilevel point of code shift information S4a outputted from the multilevel point of code shift detection unit 4a are inputted to the point of code shift correction amount calculation unit 5. Based on the demodulated data S2 and the multilevel point of code shift information S4a , the point of code shift correction amount calculation unit 5 decides which of the code shifts is generated in the multi-valued FSK code, identifies positions of a group of points of code shift including a plurality of points of code shift and present in each code-shift site of the multi-valued FSK code based on a decision result thereby obtained, generates the point of code shift correction amount information S5 based on the identified positions of the points of code shift, and outputs the generated point of code shift correction amount information S5. The other technical characteristics according to the present exemplary embodiment are similar to the exemplary embodiment 1, and will not be described again.

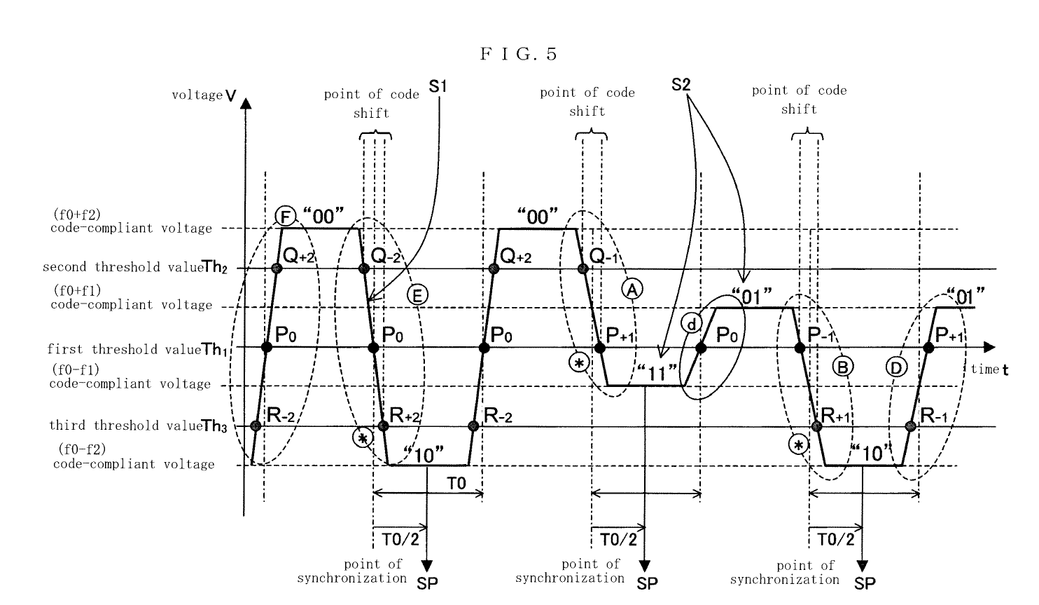

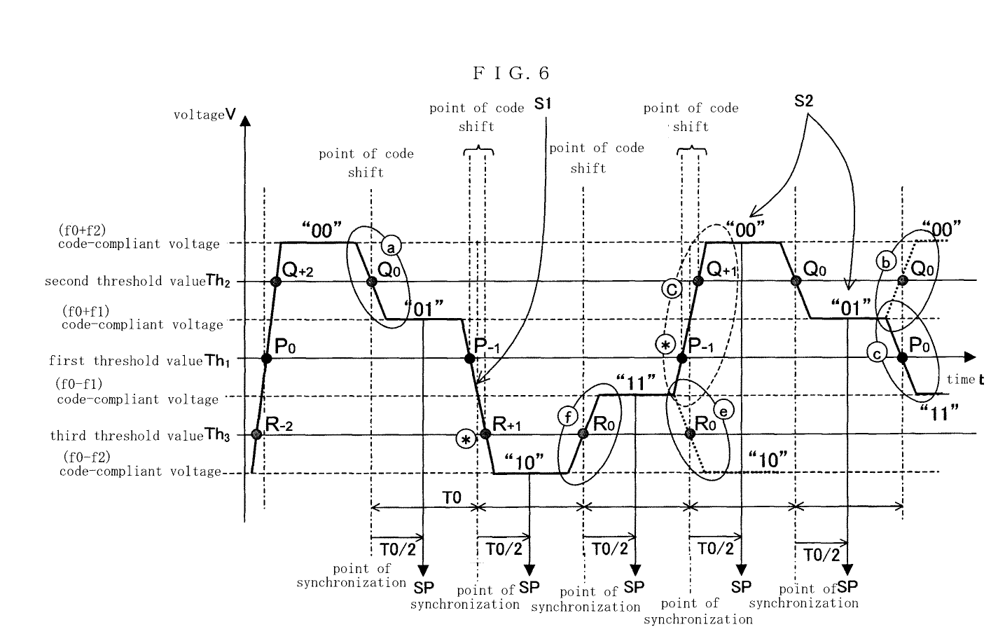

An operation of the wireless demodulation circuit according to the present exemplary embodiment thus configured is described referring to FIGS. 5-7. In the present exemplary embodiment, 4-valued FSK modulation meeting requirements similar to the exemplary embodiment 1 is described. Reference symbols a-f and A-D of FIGS. 5 and 6 are illustrated for an exemplary embodiment 4 and irrelevant to the present exemplary embodiment.

The multilevel point of code shift detection unit 4a obtains the first threshold value Th₁ and further obtains the second and third threshold values Th₂ and Th₃ as well from the threshold value information S3. The multilevel point of code shift detection unit 4a detects a point of intersection at which the demodulated baseband signal S1 intersects with the first threshold value Th₁ as the point of code shift. The multilevel point of code shift detection unit 4a further detects a point of intersection at which the demodulated baseband signal S1 intersects with the second threshold value Th₂ and a point of intersection at which the demodulated baseband signal S1 intersects with the third threshold value Th₃ as the point of code shift. The multilevel point of code shift detection unit 4a outputs the detected points of code shift (points of intersection) as the multilevel point of code shift information S4a to the point of code shift correction amount calculation unit 5.

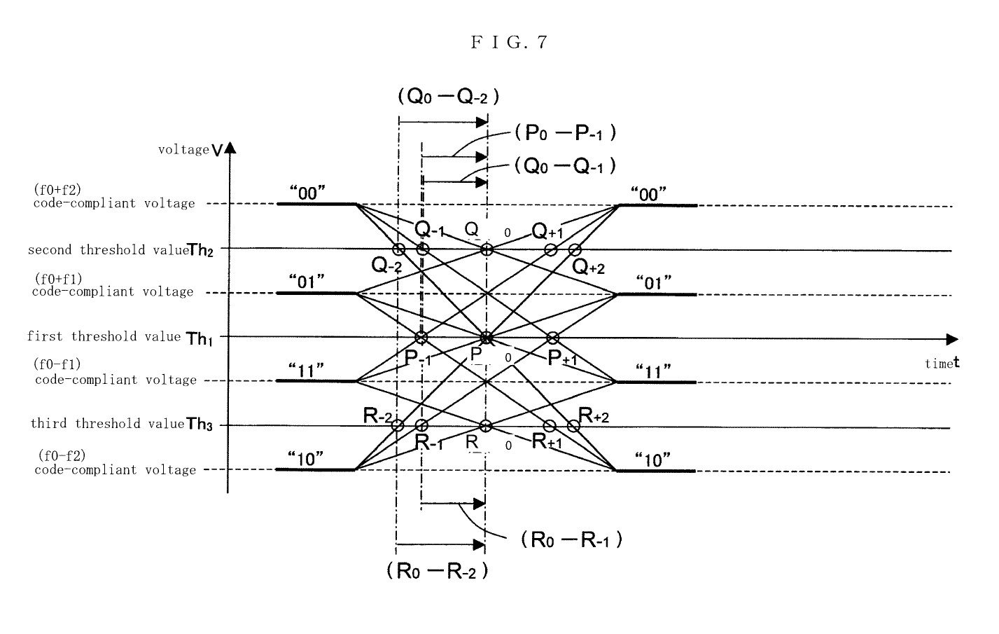

Based on the demodulated data S2 (“00”, “01”, “11”, and “10”), the point of code shift correction amount calculation unit 5 decides which of the code shifts is generated in the multi-valued FSK code superimposed on the multi-valued FSK signal. FIG. 7 illustrates 3×4=12 code shifts. The points of code shift to be detected include all of the points of code shift P₋₁, P₀, and P₊₁ which are three points at which the demodulated baseband signal S1 intersects with the first threshold value Th₁, points of code shift Q₋₂, Q₋₁, Q₀, Q₊₁, Q₊₂ which are five points at which the demodulated baseband signal S1 intersects with the second threshold value Th₂, and points of code shift R₋₂, R₋₁, R₀, R₊₁, R₊₂ which are five points o at which the demodulated baseband signal S1 intersects with the third threshold value Th₃.

The following points of code shift are detected in relation to the second threshold value Th₂:
point of code shift Q₋₂ (minus-shifted) in the code shift of the multi-valued FSK code from the first level “00” to the fourth level “10”;
point of code shift Q₋₁ (minus-shifted) in the code shift of the multi-valued FSK code from the first level “00” to the third level “11”
point of code shift Q₀ (unshifted center point) in the code shift of the multi-valued FSK code from the first level “00” to the second level “01” and the code shift of the multi-valued FSK code from the second level “01” to the first level “00”;
point of code shift Q₊₁(plus-shifted) in the code shift of the multi-valued FSK code from the third level “11” to the first level “00”; and
point of code shift Q₊₂ (plus-shifted) in the code shift of the multi-valued FSK code from the fourth level “10” to the first level “00”.

The following points of code shift are detected in relation to the second threshold value Th₃:
point of code shift R₋₂ (minus-shifted) in the code shift of the multi-valued FSK code from the fourth level “10” to the first level “00”;
point of code shift R₋₁ (minus-shifted) in the code shift of the multi-valued FSK code from the fourth level “10” to the second level “01”
point of code shift R₀ (unshifted center point) in the code shift of the multi-valued FSK code from the fourth level “10” to the third level “11” and the code shift of the multi-valued FSK code from the third level “11” to the fourth level “10”;
point of code shift R₊₁(plus-shifted) in the code shift of the multi-valued FSK code from the second level “01” to the fourth level “10”; and
point of code shift R₊₂ (plus-shifted) in the code shift of the multi-valued FSK code from the first level “00” to the fourth level “10”.

Since differentials between the respective points of code shift and the ideal points of code shift Q₀ and R₀ are previously known, the point of code shift correction amount calculation unit 5, once it is detected that the demodulated baseband signal S1 intersects with any of the points of code shift, handles differentials between the respective points of code shift and the ideal points of code shift Q₀ and R₀, (Q₀−Q₋₂), (Q₀−Q₋₁), (R₀−Q₋₂), and (R₀−R₋₁), as the point of code shift correction amount information S5. A symbol * illustrated in the drawing denotes a point of synchronization at which the correction is made. The present exemplary embodiment, wherein all of the points of code shift necessary for detecting the code shift are obtained and effectively used, can more accurately calculate the data sampling point SP.

As described so far, the present exemplary embodiment uses not only the first threshold value Th₁ but also the second and third threshold values Th₂ and Th₃, thereby accurately acquiring information on all of the points of code shift (data sampling point SP). The present exemplary embodiment thus technically advantageous can greatly contribute to higher data transmission rates.

It is unavoidable in the present exemplary embodiment that the circuit configuration is relatively complicated to obtain the expected effect. To simplify the circuit configuration, therefore, the present exemplary embodiment may use only a part of the information. Of the three points of code shift R₋₂, P₀, and Q₊₂ where the demodulated baseband signal S1 intersects in the code shift from the fourth level “10” to the first level “00”, the point of code shift P₀ is used as the most useful information. Therefore, the point of code shift correction amount information S5 of the points of code shift R₋₂ and Q₊₂ may be discarded. The point of code shift information to be desirably obtained (data sampling point SP) is still available. Thus, the present exemplary embodiment can flexibly provide a technical configuration most suitable for an intended transmission rate.

### Exemplary Embodiment 3

In the wireless demodulation circuits according to the exemplary embodiments 1 and 2, the demodulated data S2 is used to monitor the code shift. A wireless demodulation circuit according to an exemplary embodiment 3 of the present invention described below is configured to decide the code shift from an amount of demodulation voltage change and a voltage level after the voltage change of the pre-coding demodulated baseband signal S1.

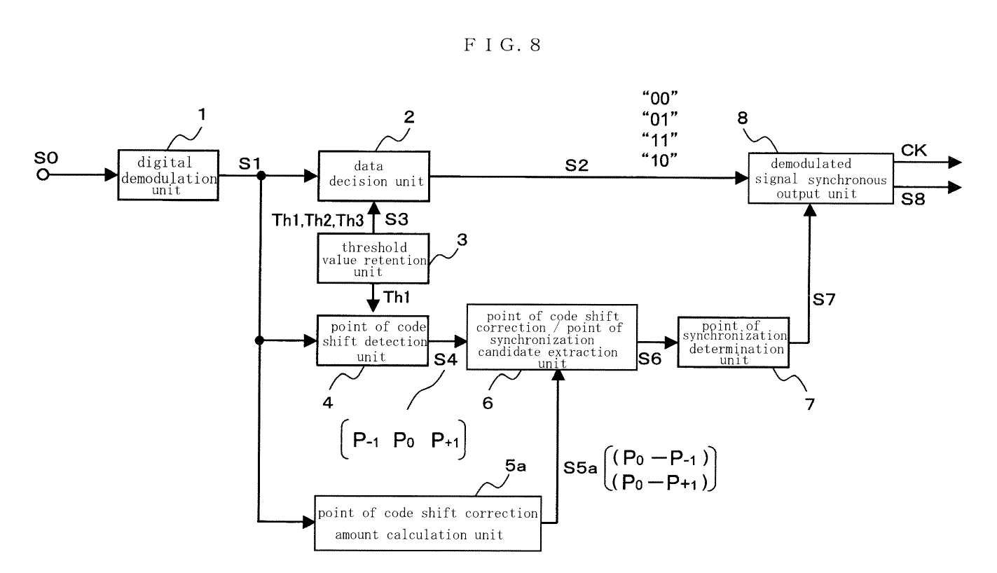

FIG. 8 is a block diagram of a wireless demodulation circuit according to the exemplary embodiment 3. Of reference symbols illustrated in FIG. 8, the same reference symbols as those illustrated in FIG. 1 according to the exemplary embodiment 1 denote the same structural elements. The present exemplary embodiment is technically characterized as follows. The point of code shift correction amount calculation unit 5 which calculates the point of code shift correction amount depending on the code shift is replaced with a point of code shift correction amount calculation unit 5a configured to calculate the point of code shift correction amount from an amount of voltage change. The demodulated baseband signal S1 outputted from the digital demodulation unit 1 is inputted to the point of code shift correction amount calculation unit 5a. The point of code shift correction amount calculation unit 5a decides an amount of demodulation voltage change in the inputted demodulated baseband signal S1, generates a point of code shift correction amount information S5a [(P₀−P₋₁), (P₀−P₊₁), or 0] relating to the amount of voltage change and the center point of code shift, and outputs the generated point of code shift correction amount information S5a to the point of code shift correction/point of synchronization candidate extraction unit 6.

The point of code shift correction/point of synchronization candidate extraction unit 6 is configured to correct the points of code shift indicated by the point of code shift information S4 (P₋₁, P₀, P₊₁) supplied from the point of code shift detection unit 4 on the time axis based on the point of code shift correction amount information S5a.

The other technical characteristics according to the present exemplary embodiment are similar to the exemplary embodiment 1, and will not be described again. The point of code shift detection unit 4 according to the present exemplary embodiment is configured to detect the point of code shift based on the points of intersection between the demodulated baseband signal S1 outputted from the digital demodulation unit 1 and the first threshold value Th₁ (which is similar to the exemplary embodiment 1) and output the point of code shift information S4 (P₋₁, P₀, P₊₁) obtained from the detection to the point of code shift correction/point of synchronization candidate extraction unit 6. Though the first threshold value Th₁ alone is used to decide the point of code shift, all of the points of code shift P₋₁, P₀, and P₊₁ are once the point of code shift is detected.

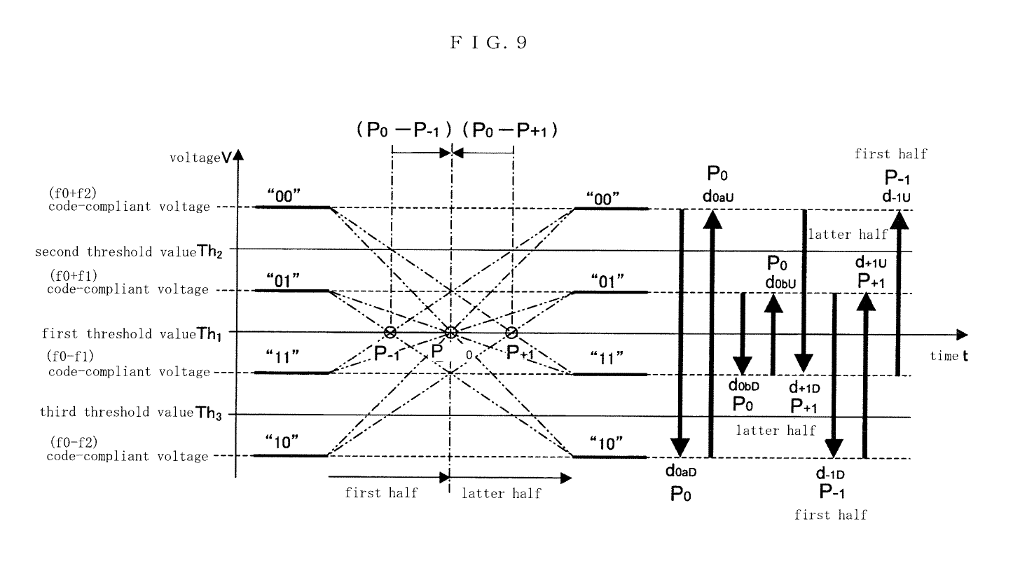

An operation of the wireless demodulation circuit according to the present exemplary embodiment thus configured is described referring to FIG. 9. In FIG. 9, multilevel of code-compliant voltages are used. Though the code-compliant voltages respectively correspond to “00”, “01”, “11”, and “10”, these values are not used in the present exemplary embodiment to correct the point of code shift.

The point of code shift correction amount calculation unit 5a retains a current demodulation voltage value and also demodulation voltage values obtained over a given period of time to constantly monitor voltage changes in the voltage values. Thought the given period of time is not particularly limited, it is necessary to retain at least demodulation voltages over one symbol period of the transmission rate (sampling cycle). The detected voltage changes thus obtained are used to decide which of the points of code shift P₋₁, P₀, and P₊₁ is the point of intersection at which the demodulated baseband signal S1 intersects with the first threshold value Th₁.

The demodulation voltage values are, from higher voltage values:
(f0+f2) code-compliant voltage
(f0+f1) code-compliant voltage
(f0−f1) code-compliant voltage
(f0−f2) code-compliant voltage

There is a magnitude relationship between these demodulation voltages and the first—third threshold values Th₁, Th₂, and Th₃.

(f0+f2)>Th₂>(f0+f1)>Th₁>(f0−f1)>Th₃>(f0−f2)

The amounts of voltage change from the respective code-compliant voltages to the other voltage code-compliant voltages are respectively called as follows.
The amount of voltage change from the (f0+f2) code-compliant voltage to the (f0−f2) code-compliant voltage is called an amount of voltage change d_{0aD}.
The amount of voltage change from the (f0−f2) code-compliant voltage to the (f0+f2) code-compliant voltage is called an amount of voltage change d₀ₐᵤ.
The amount of voltage change from the (f0+f1) code-compliant voltage to the (f0−f1) code-compliant voltage is called an amount of voltage change d_{0bD}.
The amount of voltage change from the (f0−f1) code-compliant voltage to the (f0+f1) code-compliant voltage is called an amount of voltage change d_{0bU}.
The amount of voltage change from the (f0+f2) code-compliant voltage to the (f0−f1) code-compliant voltage is called an amount of voltage change d_{+1D}.
The amount of voltage change from the (f0−f1) code-compliant voltage to the (f0 +f2) code-compliant voltage is called an amount of voltage change d_{-1U}.
The amount of voltage change from the (f0+f1) code-compliant voltage to the (f0−f2) code-compliant voltage is called an amount of voltage change d_{-1D}.
The amount of voltage change from the (f0−f2) code-compliant voltage to the (f0+f1) code-compliant voltage is called an amount of voltage change d_{+1U}.

The amounts of voltage change and the points of code shift are characterized as follows.
The center point of code shift P₀ corresponds to the amount of voltage change d₀ₐᵤ, amount of voltage change d_{0bD}, and amount of voltage change d_{0bu}, and 0 is applied to the point of code shift correction amount information S5a for these amounts of voltage change d_{0aU}, d_{0bD}, and d_{0bU}.
The plus-shifted point of code shift P₊₁ corresponds to the amount of voltage change _{d+1D,} and the differential [(P₀−P₊₁): negative value] is applied to the point of code shift correction amount information S5a for the amount of voltage change d_{+1D}.
The plus-shifted point of code shift P₋₁ corresponds to the amount of voltage change d_{-1D}, and (P₀−P₊₁) is applied to the point of code shift correction amount information S5a for the amount of voltage change d_{-1D}.
The plus-shifted point of code shift P₊₁ corresponds to the amount of voltage change d_{-1U}, and [(P₀−P₊₁): negative value] is applied to the point of code shift correction amount information S5a for the amount of voltage change d_{+1U}.
The minus-shifted point of code shift P₋₁ corresponds to the amount of voltage change d_{-1U}, and (P₀−P₋₁) is applied to the point of code shift correction amount information S5a corresponding to the amount of voltage change d_{-1U}.

The amount of voltage change d_{+1D} and the amount of voltage change d_{-1D} both showing downward voltage changes are compared to each other. The amount of voltage change d_{+1D} and the amount of voltage change d_{-1D} are equal to each other, however, they have different points of code shift (point of code shift P₊₁ and point of code shift P₋₁), which is different to decision of the point of code shift based on the code shift. The amount of voltage change d_{-1U} and the amount of voltage change d_{-1U} both showing upward voltage changes are compared to each other. The amount of voltage change d_{-1U} and the amount of voltage change d_{-1U} are equal to each other, however, they have different points of code shift (point of code shift P₊₁ and point of code shift P₋₁). Therefore, it is necessary to evaluate the different points of code shift. Below is given a detailed description.

The amounts of voltage change are orthogonal to the direction of time axis, lacking any information of the direction of time axis. The voltage change starts with a certain level of code-compliant voltage, increasing or decreasing the voltage. When the voltage level reaches a different level and stays at the level for a certain period of time, the level is a different code-compliant voltage level. The amount of voltage change is a difference between a level of code-compliant voltage and another level of code-compliant voltage level. Though the amount of voltage change per se does not involve any information related to the time axis, whether a timing by which the demodulated baseband signal S1 intersects with the first threshold value Th₁ (hereinafter, called intersection timing) arrives during a first-half timeframe or a latter-half timeframe can be determined, in other words, a temporal relationship of the timing to the center point of code shift P₀ can be determined based on the dimension of a differential between the voltage level after the voltage change and the first threshold value Th₁. As a result, which of the points of code shift is the detected point of code shift on the time axis can be identified. In the case where the intersection timing arrives during the first-half timeframe, it is determined that the demodulated baseband signal S1 intersects with the first threshold value Th₁ at the point of code shift P₋₁. In the case where the intersection timing arrives during the latter-half timeframe, it is determined that the demodulated baseband signal S1 intersects with the first threshold value Th₁ at the point of code shift P₊₁. Describing the first-half timeframe and latter-half timeframe, a timeframe earlier than a center time point of a maximum time width where the timing possibly arrives is called the first-half timeframe, while a timeframe later than the center time point is called the latter side.

When the position of the point of code shift in the direction of time axis is thus determined, a differential to the ideal point of code shift, (P₀−P₋₁) or [(P₀−P₊₁): negative value], is calculated. The point of code shift correction amount calculation unit 5a outputs the calculated differential to the point of code shift correction/point of synchronization candidate extraction unit 6 as the point of code shift correction amount information S5a. The rest of the operation is similar to that of the exemplary embodiment 1.

As compared to the prior art wherein the center point of code shift alone is handled, the present exemplary embodiment uses more points of code shift (P₋₁, P₀, and P₊₁) to calculate the point of code shift correction amount, (P₀−P₋₁) or [(P₀−P₊₁): negative value], from the relationship of the demodulated baseband signal S1 to the amount of voltage change and the center point of code shift. Then, the minus-shifted point of code shift P₋₁ or the plus-shifted point of code shift P₊₁ is corrected based on the calculated point of code shift correction amount, and the corrected point of code shift is used as the point of synchronization candidate. This helps to more accurately determine the data sampling point, thereby improving the accuracy of data judgment during fast data transmission. When the point of synchronization is followed during wireless data reception, a clock error can be more accurately corrected in real time during communication, which greatly contributes to faster wireless communication. Further, the point of code shift correction amount is calculated not based on the shift of the multi-valued FSK code but based on the relationship of the demodulated baseband signal S1 to the amount of voltage change and the center point of code shift. Therefore, the data sampling point can be accurately obtained in a startup operation where the data sampling point is unlikely to be accurate, and the data sampling point in the start-up operation can be more quickly and accurately narrowed down.

### Exemplary Embodiment 4

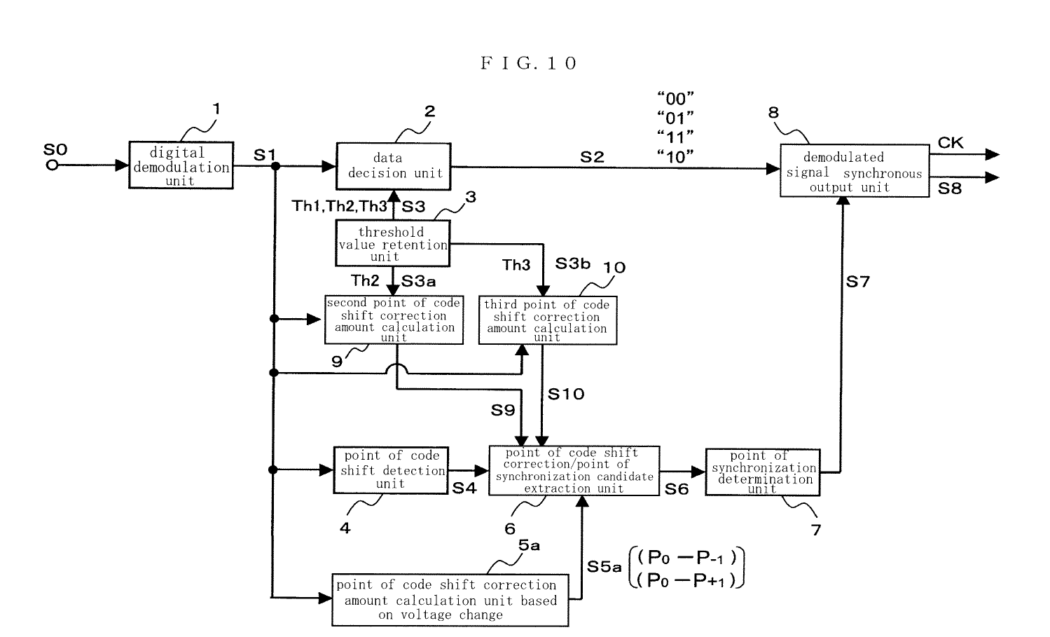

FIG. 10 is a block diagram of a wireless demodulation circuit according to an exemplary embodiment 4 of the present invention. The same reference symbols as those illustrated in the exemplary embodiments 1-3 denote the same structural elements. The wireless demodulation circuit according to the present exemplary embodiment further comprises a second point of code shift correction amount calculation unit 9 and a third point of code shift correction amount calculation unit 10. The demodulated baseband signal S1 outputted from the digital demodulation unit 1 and a second threshold value information S3a outputted from the threshold value retention unit 3 are supplied to the second point of code shift correction amount calculation unit 9. The second point of code shift correction amount calculation unit 9 decides a point of intersection at which the demodulated baseband signal S1 intersects with the second threshold value Th₂, and outputs a decision result thereby obtained to the point of code shift correction/point of synchronization candidate extraction unit 6 as a second point of code shift correction amount information S9.

The demodulated baseband signal S1 outputted from the digital demodulation unit 1 and a third threshold value information S3b outputted from the threshold value retention unit 3 are supplied to the third point of code shift correction amount calculation unit 10. The third point of code shift correction amount calculation unit 10 decides a point of intersection at which the demodulated baseband signal S1 intersects with the third threshold value Th₂, and outputs a decision result thereby obtained to the point of code shift correction/point of synchronization candidate extraction unit 6 as a third point of code shift correction amount information S10.

The functions of the second and third point of code shift correction amount calculation units 9 and 10 are substantially similar to that of the point of code shift correction amount calculation unit 5a. The other technical characteristics according to the present exemplary embodiment are similar to the exemplary embodiment 3, and will not be described again.

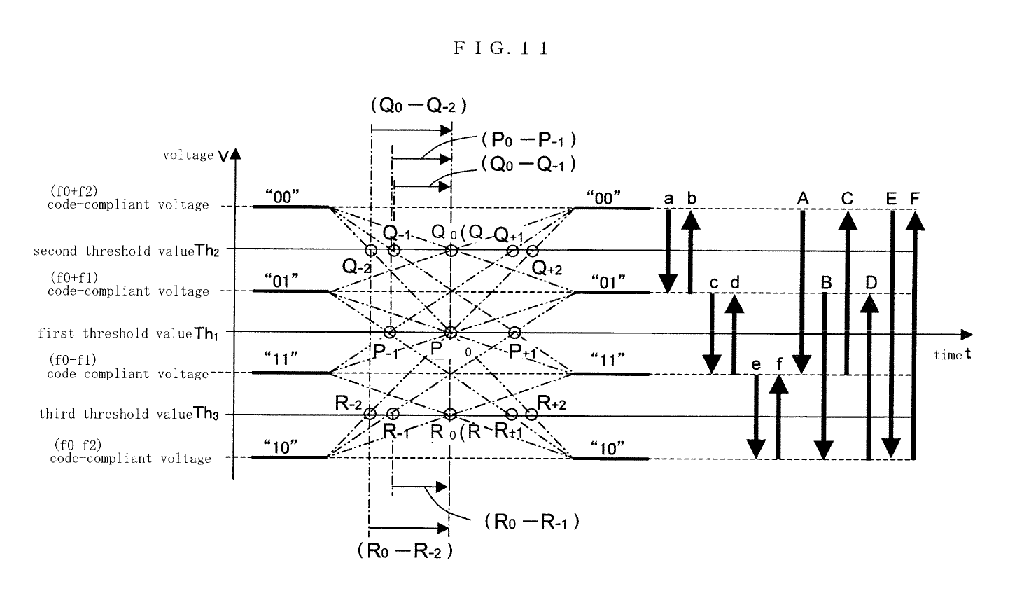

An operation of the wireless demodulation circuit according to the present exemplary embodiment thus configured is described referring to FIG. 11, and also FIGS. 5 and 6.

The second point of code shift correction amount calculation unit 9 compares the changing signal level of the demodulated baseband signal S1 to the second threshold value Th₂. When it is detected that the changing signal level intersects with the second threshold value Th₂, the second point of code shift correction amount calculation unit 9 calculates the point of code shift correction amount based on a detected point of intersection and outputs the calculated point of code shift correction amount to the point of code shift correction/point of synchronization candidate extraction unit 6 as the second point of code shift correction amount information S9.

Similarly, the third point of code shift correction amount calculation unit 10 compares the changing signal level of the demodulated baseband signal S1 to the third threshold value Th₃. When it is detected that the changing signal level intersects with the third threshold value Th₃, the third point of code shift correction amount calculation unit 10 calculates the point of code shift correction amount based on a detected point of intersection and outputs the calculated point of code shift correction amount to the point of code shift correction/point of synchronization candidate extraction unit 6 as the third point of code shift correction amount information S10.

The code shifts of the demodulated baseband signal S1 are specifically described as follow.
voltage change of the demodulated baseband signal S1 from the (f0+f2) code-compliant voltage to the (f0+f1) code-compliant voltage (hereinafter, called first voltage change)
voltage change of the demodulated baseband signal S1 from the (f0+f1) code-compliant voltage to the (f0+f2) code-compliant voltage (hereinafter, called second voltage change)
voltage change of the demodulated baseband signal S1 from the (f0+f1) code-compliant voltage to the (f0−f1) code-compliant voltage (hereinafter, called third voltage change)
voltage change of the demodulated baseband signal S1 from the (f0−f1) code-compliant voltage to the (f0+f1) code-compliant voltage (hereinafter, called fourth voltage change)
voltage change of the demodulated baseband signal S1 from the (f0−f1) code-compliant voltage to the (f0−f2) code-compliant voltage (hereinafter, called fifth voltage change)
voltage change of the demodulated baseband signal S1 from the (f0−f2) code-compliant voltage to the (f0−f1) code-compliant voltage (hereinafter, called sixth voltage change)
voltage change of the demodulated baseband signal S1 from the (f0+f2) code-compliant voltage to the (f0−f1) code-compliant voltage (hereinafter, called seventh voltage change)
voltage change of the demodulated baseband signal S1 from the (f0+f1) code-compliant voltage to the (f0−f2) code-compliant voltage (hereinafter, called eighth voltage change)
voltage change of the demodulated baseband signal S1 from the (f0−f1) code-compliant voltage to the (f0+f2) code-compliant voltage (hereinafter, called ninth voltage change)
voltage change of the demodulated baseband signal S1 from the (f0−f2) code-compliant voltage to the (f0+f1) code-compliant voltage (hereinafter, called tenth voltage change)
voltage change of the demodulated baseband signal S1 from the (f0+f2) code-compliant voltage to the (f0−f2) code-compliant voltage (hereinafter, called 11th voltage change)
voltage change of the demodulated baseband signal S1 from the (f0−f2) code-compliant voltage to the (f0+f2) code-compliant voltage (hereinafter, called 12th voltage change)

In the first and second voltage changes, the amount of voltage change in the demodulation voltage is ⅔ times of the degree of modulation, and the changing signal level intersects with the second threshold value Th₂ alone. Further, the changing signal level intersects with the second threshold value Th₂ at the ideal point of code shift Qᵢ (see a and b of FIG. 11 and FIG. 6). Based on the finding, the point of code shift correction amount calculation unit 5a, second point of code shift correction amount calculation unit 9, and third point of code shift correction amount calculation unit 10 decide that the point of intersection Q₀ between the demodulated baseband signal S1 and the second threshold value Th₂ is consistent with the ideal point of code shift Qᵢ (point of code shift correction amount is 0) when the amount of voltage change in the demodulation voltage is ⅔ times of the degree of modulation, and the changing signal level intersects with the second threshold value Th₂ alone. Then, the point of code shift correction amount calculation unit 5a, second point of code shift correction amount calculation unit 9, and third point of code shift correction amount calculation unit 10 respectively output (0) to the point of code shift correction/point of synchronization candidate extraction unit 6 as the point of code shift correction amount information S5a, second point of code shift correction amount information S9, and third point of code shift correction amount information S10. The point of code shift correction/point of synchronization candidate extraction unit 6 stores therein the inputted point of code shift correction amount information S5a (0), second point of code shift correction amount information S9 (0), and third point of code shift correction amount information S10 (0).

In the third and fourth voltage changes, the amount of voltage change in the demodulation voltage is ⅔ times of the degree of modulation, and the changing signal level intersects with the first threshold value Th₁ alone. Further, the changing signal level intersects with the first threshold value Th₁ at the ideal point of code shift Pᵢ (see c and d of FIG. 11 and FIG. 6). Based on the finding, the point of code shift correction amount calculation unit 5a, second point of code shift correction amount calculation unit 9, and third point of code shift correction amount calculation unit 10 decide that the point of intersection P₀ between the demodulated baseband signal S1 and the first threshold value Th₁ is consistent with the ideal point of code shift Pᵢ (point of code shift correction amount is 0) when the amount of voltage change in the demodulation voltage is ⅔ times of the degree of modulation, and the changing signal level intersects with the first threshold value Th₁ alone. Then, the point of code shift correction amount calculation unit 5a, second point of code shift correction amount calculation unit 9, and third point of code shift correction amount calculation unit 10 respectively output (0) to the point of code shift correction/point of synchronization candidate extraction unit 6 as the point of code shift correction amount information S5a, second point of code shift correction amount information S9, and third point of code shift correction amount information S10. The point of code shift correction/point of synchronization candidate extraction unit 6 stores therein the inputted point of code shift correction amount information S5a (0), second point of code shift correction amount information S9 (0), and third point of code shift correction amount information S10 (0).

In the fifth and sixth voltage changes, the amount of voltage change in the demodulation voltage is ⅔ times of the degree of modulation, and the changing signal level intersects with the third threshold value Th₃ alone. Further, the changing signal level intersects with the third threshold value Th₃ at the ideal point of code shift Rᵢ (see e and f of FIG. 11 and FIG. 6). Based on the finding, the point of code shift correction amount calculation unit 5a, second point of code shift correction amount calculation unit 9, and third point of code shift correction amount calculation unit 10 decide that the point of intersection R₀ between the demodulated baseband signal S1 and the third threshold value Th₃ is consistent with the ideal point of code shift Rᵢ (point of code shift correction amount is 0) when the amount of voltage change in the demodulation voltage is ⅔ times of the degree of modulation, and the changing signal level intersects with the third threshold value Th₃ alone. Then, the point of code shift correction amount calculation unit 5a, second point of code shift correction amount calculation unit 9, and third point of code shift correction amount calculation unit 10 respectively output (0) to the point of code shift correction/point of synchronization candidate extraction unit 6 as the point of code shift correction amount information S5a, second point of code shift correction amount information S9, and third point of code shift correction amount information S10. The point of code shift correction/point of synchronization candidate extraction unit 6 stores therein the inputted point of code shift correction amount information S5a (0), second point of code shift correction amount information S9 (0), and third point of code shift correction amount information S10 (0).

In the seventh voltage change, the amount of voltage change in the demodulation voltage is 4/3 times of the degree of modulation, and the changing signal level intersects with the second threshold value Th₂ and the first threshold value Th₁ in the order of Th₂→Th₁. Further, the changing signal level intersects with the second threshold value Th₂ at the point of intersection Q₋₁ and intersects with the first threshold value Th₁ at the point of intersection P₊₁ (see A of FIG. 11 and FIG. 6). The point of intersection Q₋₁ is temporally before the ideal point of code shift Qᵢ on the time axis by the differential (Qᵢ−Q₋₁), and (Qᵢ−Q₋₁) is the known information. Based on the finding, the point of code shift correction amount calculation unit 5a, second point of code shift correction amount calculation unit 9, and third point of code shift correction amount calculation unit 10 decide that the point of intersection Q₋₁ is temporally before the ideal point of code shift Qᵢ on the time axis by the differential (Q₀−Qᵢ) when the amount of voltage change in the demodulation voltage is 4/3 times of the degree of modulation, and the changing signal level intersects with the second threshold value Th₂ and the first threshold value Th₁. Then, the point of code shift correction amount calculation unit 5a, second point of code shift correction amount calculation unit 9, and third point of code shift correction amount calculation unit 10 respectively output S5a (0), S9 (Q₀−Qᵢ), and S10 (0) to the point of code shift correction/point of synchronization candidate extraction unit 6 as the point of code shift correction amount information S5a, second point of code shift correction amount information S9, and third point of code shift correction amount information S10. The point of code shift correction/point of synchronization candidate extraction unit 6 stores therein the inputted point of code shift correction amount information S5a (0), second point of code shift correction amount information S9 (Q₀−Qᵢ), and third point of code shift correction amount information S10 (0).

In the eighth voltage change, the amount of voltage change in the demodulation voltage is 4/3 times of the degree of modulation, and the changing signal level intersects with the first threshold value Th₁ and the third threshold value Th₃ in the order of Th₁→Th₃. Further, the changing signal level intersects with the first threshold value Th₁ at the point of intersection P₋₁ and further intersects with the third threshold value Th₃ at the point of intersection R₊₁ (see B of FIG. 11 and FIG. 6). The point of intersection P₋₁ is temporally before the ideal point of code shift Pᵢ on the time axis by the differential (Pᵢ-31 P₋₁), and (Pᵢ−P₋₁) is the known information. Based on the finding, the point of code shift correction amount calculation unit 5a, second point of code shift correction amount calculation unit 9, and third point of code shift correction amount calculation unit 10 decide that the point of intersection P₋₁ is temporally before the ideal point of code shift Pᵢ on the time axis by the differential (P₀−P₋₁) when the amount of voltage change in the demodulation voltage is 4/3 times of the degree of modulation, and the changing signal level intersects with the first threshold value Th₁ and the third threshold value Th₃. Then, the point of code shift correction amount calculation unit 5a, second point of code shift correction amount calculation unit 9, and third point of code shift correction amount calculation unit 10 respectively output S5a (0), S9 (P₀−Pᵢ), and S10 (0) to the point of code shift correction/point of synchronization candidate extraction unit 6 as the point of code shift correction amount information S5a, second point of code shift correction amount information S9, and third point of code shift correction amount information S10. The point of code shift correction/point of synchronization candidate extraction unit 6 stores therein the inputted point of code shift correction amount information S5a (0), second point of code shift correction amount information S9 (P₀−Pᵢ), and third point of code shift correction amount information S10 (0).

In the ninth voltage change, the amount of voltage change in the demodulation voltage is 4/3 times of the degree of modulation, and the changing signal level intersects with the first threshold value Th₁ and the second threshold value Th₂ in the order of Th₁→Th₂. Further, the changing signal level intersects with the first threshold value Th₁ at the point of intersection P₋₁ and intersects with the second threshold value Thₑ at the point of intersection Q₊₁ (see C of FIG. 11 and FIG. 6). The point of intersection P₋₁ is temporally before the ideal point of code shift Pᵢ on the time axis by the differential (Pᵢ−P₋₁), and (Pᵢ−P₋₁) is the known information. Based on the finding, the point of code shift correction amount calculation unit 5a, second point of code shift correction amount calculation unit 9, and third point of code shift correction amount calculation unit 10 decide that the point of intersection P₋₁ is temporally before the ideal point of code shift P₀ on the time axis by the differential (Pᵢ−P₋₁) when the amount of voltage change in the demodulation voltage is 4/3 times of the degree of modulation, and the changing signal level intersects with the first threshold value Th₁ and the second threshold value Th₂. Then, the point of code shift correction amount calculation unit 5a, second point of code shift correction amount calculation unit 9, and third point of code shift correction amount calculation unit 10 respectively output S5a (0), S9 (P₀−Pᵢ), and S10 (0) to the point of code shift correction/point of synchronization candidate extraction unit 6 as the point of code shift correction amount information S5a, second point of code shift correction amount information S9, and third point of code shift correction amount information S10. The point of code shift correction/point of synchronization candidate extraction unit 6 stores therein the inputted point of code shift correction amount information S5a (0), second point of code shift correction amount information S9 (P₀−Pᵢ), and third point of code shift correction amount information S10 (0).

In the tenth voltage change, the amount of voltage change in the demodulation voltage is 4/3 times of the degree of modulation, and the changing signal level intersects with the third threshold value Th₃ and the first threshold value Th₁ in the order of Th₃→Th₁. Further, the changing signal level intersects with the third threshold value Th₃ at the point of intersection R₋₁ and intersects with the first threshold value Th₁ at the point of intersection P₊₁ (see D of FIG. 11 and FIG. 6). The point of intersection R₋₁ is temporally before the ideal point of code shift Rᵢ on the time axis by the differential (Rᵢ−R₋₁), and (Rᵢ−R₋₁) is the known information. Based on the finding, the point of code shift correction amount calculation unit 5a, second point of code shift correction amount calculation unit 9, and third point of code shift correction amount calculation unit 10 decide that the point of intersection R₋₁ is temporally before the ideal point of code shift R₀ on the time axis by the differential (R₀−R₋₁) when the amount of voltage change in the demodulation voltage is 4/3 times of the degree of modulation, and the changing signal level intersects with the third threshold value Th₃ and the first threshold value Th₁. Then, the point of code shift correction amount calculation unit 5a, second point of code shift correction amount calculation unit 9, and third point of code shift correction amount calculation unit 10 respectively output S5a (0), S9 (0), and S10 (R₀−Rᵢ) to the point of code shift correction/point of synchronization candidate extraction unit 6 as the point of code shift correction amount information S5a, second point of code shift correction amount information S9, and third point of code shift correction amount information S10. The point of code shift correction/point of synchronization candidate extraction unit 6 stores therein the inputted point of code shift correction amount information S5a (0), second point of code shift correction amount information S9 (0), and third point of code shift correction amount information S10 (R₀−Rᵢ).

In the 11th voltage change, the amount of voltage change in the demodulation voltage is twice of the degree of modulation, and the changing signal level intersects with the second threshold value Th₂, first threshold value Th₁, and third threshold value Th₃ in the order of Th₂→Th₁→Th₃. Further, the changing signal level intersects with the second threshold value Th₂ at the point of intersection Q₋₂, intersects with the first threshold value Th₁ at the point of intersection P₀, and intersects with the third threshold value Th₃ at the point of intersection R₊₂ (see E of FIG. 11 and FIG. 6). Based on the finding, the point of code shift correction amount calculation unit 5a, second point of code shift correction amount calculation unit 9, and third point of code shift correction amount calculation unit 10 decide that the point of intersection Q₋₂ is temporally before the ideal point of code shift Qᵢ on the time axis by the differential (Qᵢ−Q₋₂) when the amount of voltage change in the demodulation voltage is twice of the degree of modulation, and the changing signal level intersects with the second threshold value Th₂, first threshold value Th₁, and third threshold value Th₃. Then, the point of code shift correction amount calculation unit 5a, second point of code shift correction amount calculation unit 9, and third point of code shift correction amount calculation unit 10 respectively output S5a (0), S9 (Qᵢ−Q₋₂), and S10 (0) to the point of code shift correction/point of synchronization candidate extraction unit 6 as the point of code shift correction amount information S5a, second point of code shift correction amount information S9, and third point of code shift correction amount information S10. The point of code shift correction/point of synchronization candidate extraction unit 6 stores therein the inputted point of code shift correction amount information S5a (0), second point of code shift correction amount information S9 (Qᵢ−Q₋₂), and third point of code shift correction amount information S10 (0).

In the 12th voltage change, the amount of voltage change in the demodulation voltage is twice of the degree of modulation, and the changing signal level intersects with the third threshold value Th₃, first threshold value Th₁, and second threshold value Th₂ in the order of Th₃→Th₁→Th₂. Further, the changing signal level intersects with the third threshold value Th₃ at the point of intersection R₋₂, intersects with the first threshold value Th₁ at the point of intersection P₀, and intersects with the second threshold value Th₂ at the point of intersection Q₊₂ (see E of FIG. 11 and FIG. 6). The point of intersection R₋₂ is temporally before the ideal point of code shift Q₀ on the time axis by the differential (R₀−R₋₂), and (R₀−R₋₂) is the known information. Based on the finding, the point of code shift correction amount calculation unit 5a, second point of code shift correction amount calculation unit 9, and third point of code shift correction amount calculation unit 10 decide that the point of intersection R₋₂ is temporally before the ideal point of code shift Q₀ on the time axis by the differential (R₀−R₋₂) when the amount of voltage change in the demodulation voltage is twice of the degree of modulation, and the changing signal level intersects with the third threshold value Th₃, first threshold value Th₁, and second threshold value Th₂. Then, the point of code shift correction amount calculation unit 5a, second point of code shift correction amount calculation unit 9, and third point of code shift correction amount calculation unit 10 respectively output S5a (0), S9 (0), and S10 (R₀−R₋₂) to the point of code shift correction/point of synchronization candidate extraction unit 6 as the point of code shift correction amount information S5a, second point of code shift correction amount information S9, and third point of code shift correction amount information S10. The point of code shift correction/point of synchronization candidate extraction unit 6 stores therein the inputted point of code shift correction amount information S5a (0), second point of code shift correction amount information S9 (0), and third point of code shift correction amount information S10 (R₀−R₋₂).

As described so far, in addition to the point of code shift correction amount information S5a [(P₀−P₋₁), (P₀−P₊₁), or 0] supplied from the point of code shift correction amount calculation unit 5a, the second point of code shift correction amount information S9 [(Q₀−P₋₂), (Q₀−Q₋₁), or 0] supplied from the second point of code shift correction amount calculation unit 9 and the third point of code shift correction amount information S10 [(R₀−R₋₂), (R₀−R₋₁), or 0] supplied from the third point of code shift correction amount calculation unit 10 are used to correct the point of code shift. Therefore, more information than in the exemplary embodiment 3 can be obtained and used to correct the point of code shift, and the data sampling point can be more accurately calculated in real time. Another advantage is to be able to simplify the circuit configuration.

### INDUSTRIAL APPLICABILITY

The wireless demodulation circuit according to the present invention is capable of improving a transmission rate and providing more accurate communication in the multi-valued FSK modulation wireless communication. The wireless demodulation circuit thus technically advantageous is useful for improving a communication speed in the field of wireless devices without deteriorating wireless reception characteristics.

### DESCRIPTION OF REFERENCE SYMBOLS

1 digital demodulation unit

2 data decision unit

3 threshold value retention unit

4 point of code shift detection unit

4a multilevel point of code shift detection unit

5 point of code shift correction amount calculation unit

5a point of code shift correction amount calculation unit

6 point of code shift correction/point of synchronization candidate extraction unit

7 point of synchronization determination unit

8 demodulated signal synchronous output unit

9 second point of code shift correction amount calculation unit

10 third point of code shift correction amount calculation unit

S0 multi-valued FSK signal

S1 demodulated baseband signal

S2 demodulated data

S3 threshold value information

S3a second threshold value information

S3b third threshold value information

S4 point of code shift information

S4a multilevel point of code shift information

S5 point of code shift correction amount information

S5a point of code shift correction amount information based on amount of voltage change

S6 point of synchronization candidate information

S7 definite point of synchronization information

S8 synchronous digital data

S9 second point of code shift correction amount information

S10 third point of code shift correction amount information

CK synchronous digital clock

What is claimed is:

1. A wireless demodulation circuit comprising:
a digital demodulation unit configured to generate a demodulated baseband signal having a signal level variable in a direction of time axis by demodulating a multi-valued FSK signal on which a multi-valued FSK code is superimposed;
a data decision unit configured to generate a multi-valued demodulated data by comparing the signal level to a plurality of threshold values respectively having different levels;
a point of code shift detection unit configured to sequentially detecting a point of intersection at which the signal level of the demodulated baseband signal intersects with at least one of the plurality of threshold values as a point of code shift;
a point of synchronization determination unit configured to store each of a plurality of the points of code shift as a point of synchronization candidate and determine one of the stored point of synchronization candidates having a highest degree of certainty as a definite point of synchronization; and
a demodulated signal synchronous output unit configured to generate a synchronous digital clock and set a data sampling point based on the definite point of synchronization, extract a synchronous digital data from the multi-valued demodulated data at the set data sampling point, and output the extracted synchronous digital data and the synchronous digital clock, wherein
positions of a group of the points of code shift including the plurality of the points of code shift and present in each code-shift site of the multi-valued FSK code are identified, a point of code shift correction amount including an amount of displacement between a center point of code shift centered among the group of the points of code shift in the direction of time axis and each of the points of code shift is calculated based on the identified positions of the points of code shift, and the point of code shift is corrected on a time axis based on the calculated point of code shift correction amount.

2. The wireless demodulation circuit as claimed in claim 1, further comprising:
a point of code shift correction amount calculation unit configured to identify the positions of the group of the points of code shift and calculate the point of code shift correction amount including the amount of displacement between the center point of code shift and each of the points of code shift based on the identified positions of the points of code shift; and
a point of code shift correction/point of synchronization candidate extraction unit configured to correct the point of code shift on the time axis based on the point of code shift correction amount.

3. The wireless demodulation circuit as claimed in claim 2, wherein
the point of code shift detection unit sequentially detects a point of intersection at which the signal level of the demodulated baseband signal intersects with a center threshold value centered among the plurality of threshold values in a level width direction as the point of code shift, and
the point of code shift correction amount calculation unit decides a code shift of the multi-valued FSK code relative to the center threshold value in the group of the points of code shift, identifies positions of the group of the points of code shift based on the decided code shift, and calculates the point of code shift correction amount based on the identified positions of the points of code shift.

4. The wireless demodulation circuit as claimed in claim 2, wherein
the point of code shift detection unit sequentially detects a point of intersection at which the signal level of the demodulated baseband signal intersects with each of the plurality of threshold values as the point of code shift, and
the point of code shift correction amount calculation unit decides a code shift of the multi-valued FSK code relative to each of the plurality of threshold values in the group of the points of code shift, identifies positions of the group of the points of code shift based on the decided code shift, and calculates the point of code shift correction amount based on the identified positions of the points of code shift.

5. The wireless demodulation circuit as claimed in claim 2, wherein
the point of code shift detection unit sequentially detects a point of intersection at which the signal level of the demodulated baseband signal intersects with a center threshold value centered among the plurality of threshold values in a level width direction as the point of code shift, and
the point of code shift correction amount calculation unit calculates an amount of voltage change of the demodulated baseband signal and a voltage level of the demodulated baseband signal after the voltage change in each code-shift site of the multi-valued FSK code, identifies positions of the group of the points of code shift based on the amount of voltage change and a differential between the center threshold value centered among the plurality of threshold values in the level width direction and the voltage level after the voltage change, and calculates the point of code shift correction amount based on the identified positions of the points of code shift.

6. The wireless demodulation circuit as claimed in claim 5, further comprising:
a second point of code shift correction amount calculation unit; and
a third point of code shift correction amount calculation unit, wherein
the point of code shift detection unit sequentially detects a second point of intersection at which the signal level of the demodulated baseband signal intersects with a second center threshold value having a higher level than the center threshold value as a second point of code shift,
the point of code shift detection unit sequentially detects a third point of intersection at which the signal level of the demodulated baseband signal intersects with a third center threshold value having a lower level than the center threshold value as a third point of code shift,
the second point of code shift correction amount calculation unit identifies positions of a group of the second points of code shift including a plurality of the second points of code shift and present in each code-shift site of the multi-valued FSK code, and calculates a second point of code shift correction amount including an amount of displacement between a second center point of code shift centered among the group of the second points of code shift in the direction of time axis and each of the second points of code shift based on the identified positions of the second points of code shift,
the third point of code shift correction amount calculation unit identifies positions of a group of the third points of code shift including a plurality of the third points of code shift and present in each code-shift site of the multi-valued FSK code, and calculates a third point of code shift correction amount including an amount of displacement between a third center point of code shift centered among the group of the third points of code shift in the direction of time axis and each of the third points of code shift based on the identified positions of the third points of code shift, and
the point of code shift correction/point of synchronization candidate extraction unit corrects the point of code shift on the time axis based on the point of code shift correction amount, corrects the second point of code shift on the time axis based on the second point of code shift correction amount, and corrects the third point of code shift on the time axis based on the third point of code shift correction amount.
